(19) United States
(12) Patent Application Publication
(10) Pub. No.: US 2026/0250078 A1
(43) Pub. Date: Aug. 27, 2026

(54) ROLLER CLEANING TOOL

(71) Applicant: Flexible Steel Lacing Company, Downers Grove, IL (US)

(72) Inventor: Parker Lee Jensen, Holland, MI (US)

(21) Appl. No.: 19/549,945

(22) Filed: Feb. 25, 2026

Related U.S. Application Data
(60) Provisional application No. 63/763,670, filed on Feb. 26, 2025.

(51) Int. Cl. B65G 45/12; B25G 1/08

(52) U.S. Cl. CPC B65G 45/12; B25G 1/08

(57) ABSTRACT

In one aspect, a scraping blade is provided for a roller conveyor cleaning tool. The scraping blade includes a blade body, a proximal attachment portion of the body, and an elongate shank portion of the body extending longitudinally from the proximal attachment portion. The body includes a distal tip portion extending downwardly from the shank portion. The distal tip portion includes a lower arcuate scraping edge configured to engage a cylindrical outer surface of a roller.

### CROSS-REFERENCE TO RELATED APPLICATION

This application claims the benefit of U.S. Provisional Patent App. No. 63/763,670, filed Feb. 26, 2025, which is hereby incorporated by reference in its entirety.

### TECHNICAL FIELD

This disclosure relates generally to tools for roller conveyors and, more specifically, relates to tools for removing stickers or other objects stuck on rollers of roller conveyors.

### BACKGROUND

Roller conveyors are used to convey objects, such as packages, from one location to another, such as in an airport or an e-commerce fulfillment center. Packages often have stickers with address or sorting information adhered to the package to facilitate sorting and transportation of the packages. These stickers typically have a thin paper layer to minimize the cost of the sticker and a strong adhesive layer to secure the paper layer to the package.

Stickers sometimes separate from the associated packages and adhere to rollers of roller conveyors. Once adhered to a roller of a roller conveyor, a sticker can cause premature wear of the roller of the conveyor belt, can damage a roller conveyor gap blocker supported by the roller, as well as cause faults or misreads by sensors for detecting information coded onto stickers on packages that instead read that information on the stickers separated from the packages and stuck on the rollers.

Currently, to remove a sticker from a roller of a roller conveyor, a worker uses a handheld paint scraper to scrape off the paper and as much of the adhesive of the sticker as possible. The worker then uses a cleaning fluid, such as Goo Gone®, to remove any of the remaining adhesive. This process may be labor intensive and difficult for each sticker given the strength of the adhesive and the curved outer surface of the rollers, as well as having to deal with potential turning of the roller as force is applied to the roller by the scraper. Further, there may be dozens of stickers adhered to a given roller conveyor such that removing all of the stickers from all of the roller conveyors of a facility is a time-intensive endeavor. Additionally, a worker may need to lean over or get onto a roller conveyor to access a sticker at a center of one of the rollers.

### SUMMARY

In one aspect of the present disclosure, a scraping blade is provided for a roller conveyor cleaning tool. The scraping blade includes a blade body, a proximal attachment portion of the body, and an elongate shank portion of the body extending longitudinally from the proximal attachment portion. The body includes a distal tip portion extending downwardly from the shank portion. The distal tip portion includes a lower arcuate scraping edge configured to engage a cylindrical outer surface of a roller.

In one embodiment, the blade body is of a material having a flexure modulus of at least 1.8 GPa to resist the forces involved in removing a sticker from a roller of a roller conveyor. For example, the blade body may be of a material having a flexure modulus of at least 50 GPa to resist dulling of the blade and prolong the lifespan of the blade.

In another aspect of the present disclosure, a roller cleaning tool is provided. The roller cleaning tool includes a scraping blade and an arcuate saddle portion configured to be seated against a cylindrical outer surface of a roller. The scraping blade has an arcuate scraping edge spaced from the arcuate saddle portion and configured to engage the roller cylindrical outer surface with the saddle portion seated on the cylindrical outer surface. In this manner, the roller cleaning tool enables a user to engage the arcuate scraping edge of the blade by seating the arcuate saddle portion on the cylindrical outer surface of the roller.

In one embodiment, the saddle portion has a concave lower surface with a first radius of curvature to complement the cylindrical outer surface of the roller and the distal arcuate scraping edge of the scraping blade has a second radius of curvature that is smaller than the first radius of curvature. For example, the second radius of curvature is in the range of approximately 94% to approximately 96% of the first radius of curvature. The smaller second radius of curvature of the arcuate scraping edge causes the arcuate scraping edge to deform or flatten out and engage the roller cylindrical outer surface for the full length of the arcuate scraping edge when the arcuate saddle portion is seated on the roller. The engagement of the full length of the scraping edge with the roller cylindrical outer surface provides a wide, continuous scraping area to get under a sticker and peel the sticker away from the roller.

The present disclosure also provides a method of removing a sticker from a cylindrical outer surface of a roller. The method includes advancing a roller cleaning tool toward the roller cylindrical outer surface and engaging corner portions of an arcuate edge of a scraping blade of the roller cleaning tool with the roller cylindrical outer surface with a central portion of the arcuate edge spaced from the roller cylindrical outer surface during advancement of the roller cleaning tool toward the roller cylindrical outer surface.

The method includes deflecting the scraping blade to shift the central portion of the scraping blade arcuate edge into engagement with the roller cylindrical outer surface by seating the roller cleaning tool against the roller cylindrical outer surface. The method further includes moving the roller cleaning tool along the roller cylindrical surface toward the sticker while the corner portions and central portion of the scraping blade arcuate edge are engaged with the roller cylindrical outer surface to cause the scraping blade to remove the sticker from the cylindrical outer surface.

### BRIEF DESCRIPTION OF DRAWINGS

FIG. 1 is a perspective view of a roller cleaning tool having a handle, a cleaning head, and a blade extending distally from the cleaning head;

FIG. 2 is a front elevational view of the roller cleaning tool of FIG. 1 showing an arcuate saddle portion of the cleaning head that seats against a cylindrical outer surface of a roller and a lower arcuate scraping edge of the blade having a radius of curvature that is slightly less than the curvature of the arcuate saddle portion;

FIG. 3 is a rearview of the roller cleaning tool of FIG. 1 showing the scraping blade projecting below the saddle portion of the roller cleaning tool;

FIG. 4 is a cross-sectional view taken along line 4-4 in FIG. 2 showing structural portions of the roller cleaning tool that orient the blade at an oblique angle to a longitudinal axis of a roller for engaging the arcuate scraping edge of the blade with the roller;

FIG. 5 is a plan view of the blade of the roller cleaning tool of FIG. 1 showing side recesses of a proximal attachment portion of the blade for receiving gripping portions of a blade retainer of the roller cleaning tool that releasably secures the blade to the cleaning head;

FIG. 6 is a rear elevational view of the blade of FIG. 5 showing the arcuate scraping edge;

FIG. 7 is a side elevational view of the blade of FIG. 5 showing a tapered tip portion of the blade;

FIG. 8 is a schematic side view of the blade before the roller cleaning tool is engaged against the roller;

FIG. 9 is a front elevational view of a distal portion of the roller cleaning tool of FIG. 1 and a roller showing a spaced orientation of the arcuate scraping edge of the blade and an outer cylindrical surface of the roller;

FIG. 10 is an enlarged view of the blade arcuate scraping edge and roller cylindrical outer surface of FIG. 9 showing the scraping edge lowered for initially contacting the roller at outer corner portions of the scraping blade;

FIG. 11 is a view similar to FIG. 10 showing a center portion of the scraping edge urged further downwardly to be engaged against the roller cylindrical outer surface causing the corner portions to exert greater force against the roller cylindrical outer surface than the center portion;

FIG. 12 is a schematic view similar to FIG. 8 showing the blade deflected or bent due to interference between the tip portion of the blade and the roller when the roller cleaning tool is engaged against the roller;

FIG. 13 is a view similar to FIG. 12 showing the tip portion of the blade worn down such that there is less bend in the blade but the tip portion still remains engaged with the roller;

FIG. 14 is a partially exploded view of the cleaning head of the roller cleaning tool of FIG. 1 showing an upper portion and a lower portion of the cleaning head;

FIG. 15 is a top plan view of the lower portion of FIG. 14 showing the distal gripping portions of the blade retainer engaged with the side recesses of the blade to secure the blade in the roller cleaning tool;

FIG. 16 is a view similar to FIG. 15 showing blade release button actuators of the blade retainer pressed toward each other causing the distal gripping portions of the blade retainer to shift apart and permit removal of the blade;

FIGS. 17-19 are perspective views of the roller cleaning tool of FIG. 1 in different sequential positions relative to a roller for removing a sticker from the roller;

FIG. 20 is a perspective view of another roller cleaning tool that may be engaged with and shifted along the length of the roller to remove stickers therefrom;

FIG. 21 is a front elevational view of the roller cleaning tool of FIG. 20 showing a lower channel of the roller cleaning tool that provides clearance for receiving a portion of the roller therein and a blade having a lower arcuate scraping edge to remove stickers from the roller;

FIG. 22 is a cross-sectional view taken along line 22-22 in FIG. 21 showing fasteners securing portions of the roller cleaning tool together and clamping the blade therebetween;

FIG. 23 is a perspective view of a roller cleaning tool having a clamp including rotary wheels to engage a roller and a blade to scrape a sticker off of the clamped roller as the roller rotates;

FIG. 24 is a top plan view of the roller cleaning tool of FIG. 23 showing a bias of a scraping edge of the blade so that the scraping edge extends obliquely relative to and across the longitudinal axis of the roller;

FIG. 25 is a side elevational view of the roller cleaning tool of FIG. 23 showing leg portions of the roller cleaning tool to which the rotary wheels are mounted so the wheels can rotatably engage the roller and support the roller cleaning tool on the roller as the roller rotates;

FIG. 26 is a cross-sectional view taken along line 26-26 in FIG. 24 showing an over-center linkage of the clamp in an engaged, clamped configuration;

FIG. 27 is a view similar to FIG. 26 showing the over-center linkage of the clamp in a disengaged, unclamped configuration;

FIG. 28 is a plan view of the blade of the roller cleaning tool of FIG. 23 showing an elongated ridge extending across the blade for engaging the roller cleaning tool and three recesses below the elongated ridge to increase the flexibility of the blade;

FIG. 29 is a side elevational view of the blade of FIG. 28 showing an inclined leading surface of the blade and the elongated ridge protruding from an upper surface of the blade;

FIGS. 30 and 31 are top plan views of a portion of the roller cleaning tool and roller of FIG. 23 showing the scraping blade engaging a sticker as the roller rotates;

FIG. 32 is a perspective view of a roller cleaning tool having a clamp to engage a roller, a blade to remove a sticker from the roller, and a drive for advancing the roller cleaning tool along the roller;

FIG. 33 is a side elevational view of the roller cleaning tool of FIG. 32 showing an upper input shaft for being driven by a power tool and a lower output shaft for rotating a drive wheel of the roller cleaning tool that advances the roller cleaning tool along the roller;

FIG. 34 is a front elevational view of the roller cleaning tool of FIG. 32 showing drive and follower pulleys that are mounted on the input and output shafts, respectively, of the drive;

FIG. 35 is a top plan view of the roller cleaning tool of FIG. 32 showing the drive wheel oriented at an oblique angle relative to an axis of rotation of the roller so that the rotation of the drive wheel causes the roller to rotate and the roller cleaning to tool to advance along the roller;

FIG. 36 is a perspective view of another roller cleaning tool having a blade for removing a sticker from a roller;

FIG. 37 is a side elevational view of the roller cleaning tool of FIG. 36 showing a lower portion of the roller cleaning tool having recesses that receive rollers downstream of the roller being scraped by the blade of the roller cleaning tool;

FIG. 38 is a perspective view of another roller cleaning tool having a cleaning head, a scraper blade projecting forwardly and downwardly from the cleaning head, and a handle projecting rearwardly and upwardly from the cleaning head;

FIG. 39 is a cross-sectional view of the cleaning tool taken along line 39-39 in FIG. 38 showing structural portions of the roller cleaning tool that orient the blade at an oblique angle for engaging an arcuate scraping edge of the blade with the roller;

FIG. 40 is a perspective view of a lower portion of the cleaning head of the roller cleaning tool of FIG. 38 showing gripping portions of a retainer of the lower portion engaged in recesses of the scraper blade;

FIG. 41 is an enlarged, top perspective view of the scraping blade of FIG. 38 showing a downward inclined distal tip portion of the scraping blade;

FIG. 42 is a top plan view of the scraping blade of FIG. 41 showing a curved juncture between a flat top surface of a shank portion of the scraping blade and a tapered lead-in surface of the distal tip portion;

FIG. 43 is a bottom perspective view of the scraping blade of FIG. 41 showing a concave tapered lower edge surface of the distal tip portion of the scraping blade;

FIG. 44A is a bottom plan view of the scraping blade of FIG. 43 showing a curved juncture between the concave tapered lower edge surface and a flat lower surface of the shank portion of the scraping blade;

FIG. 44B is a cross-sectional view taken along line 44B-44B in FIG. 42 showing the concave tapered lower edge surface of the distal tip portion of the scraping blade;

FIG. 45 is a side elevational view of the scraping blade of FIG. 41 showing the distal tip portion extending downwardly and forwardly of the shank portion of the scraping blade;

FIG. 46 is a rear elevational view of the scraping blade of FIG. 41 showing an arcuate edge of the distal tip portion;

FIG. 47 is a side view showing the scraping blade of FIG. 41 initially contacting a roller shown schematically;

FIG. 48 is a side view similar to FIG. 47 showing the blade deflected or bent due to interference between the distal tip portion of the blade and the roller when the saddle of the roller cleaning tool is seated on the roller;

FIG. 49 is a side view similar to FIG. 47 showing the distal tip portion worn down; and

FIG. 50 is a side view similar to FIG. 49 showing less bend in the blade due to the worn distal tip portion when the roller cleaning tool is seated on the roller.

### DETAILED DESCRIPTION

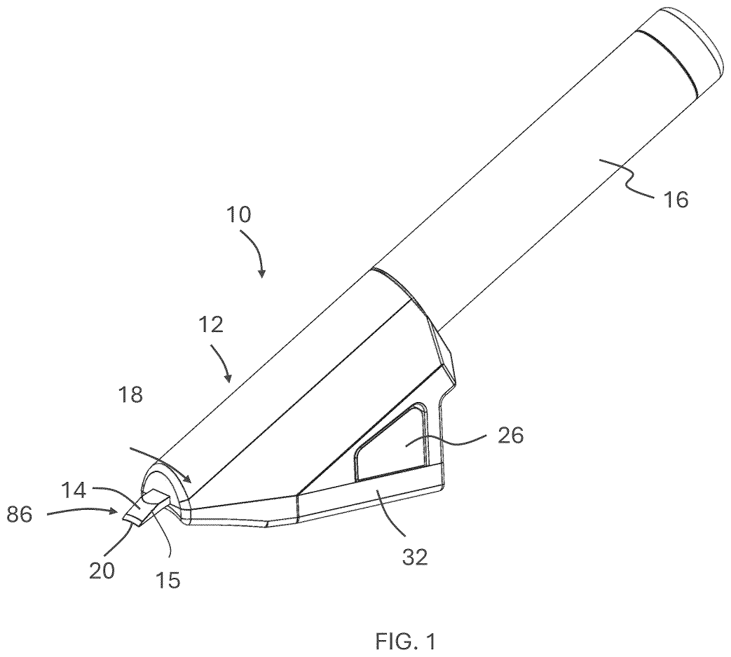

Regarding FIG. 1, a roller cleaning tool 10 is provided for removing an object stuck on a roller of a roller conveyor. The roller cleaning tool 10 may be used, for example, to remove a sticker, tape, plastic wrap, or debris from a package that has become stuck on a roller of a roller conveyor.

The roller cleaning tool 10 includes a cleaning head 12 to which a blade 14 is removably mounted. The tool 10 also includes a proximal handle 16. The cleaning head 12 has a blade holder 18 that orients the blade 14 so that an arcuate scraping edge 20 of a distal tip portion 86 of the blade 14 is positioned to scrape off a sticker adhered to the cylindrical outer surface of a roller.

The blade 14 is a wear part and has a body 15 having a unitary, one-piece construction. The blade body 15 is made of a material softer than the material of the cylindrical outer surface of the roller to avoid damaging the roller, which may be a bare metallic material (e.g., aluminum) or have a plating (e.g. zinc), plastic coating, or other protective layer. While being softer than the cylindrical outer surface of the roller, the body 15 is made of a material sufficiently rigid to resist the forces involved in peeling off a sticker from a roller. In one embodiment, the body 15 has a flexure modulus of at least 1.8 GPa to scrape a sticker off of a roller. For example, the body 15 may have a flexure modulus of at least 50 GPa to resist dulling of the blade 14 and prolong the lifespan of the blade 14. The flexure modulus of a material used for the body 15 may be determined using the ATSM D790 standard.

Further, the blade body 15 is configured to be resilient to allow the blade 14 to bend and so that its scraping edge 20 can deflect when the roller cleaning tool 10 is engaged with a roller, as discussed in greater below. For example, the blade body 15 may be made of carbon fiber filled polyphthalamide or polyphenylene sulfide (PPS). In another embodiment, the blade 14 may be made of a metallic material, such as aluminum, iron, or copper, that is softer than the material cylindrical outer surface of the roller.

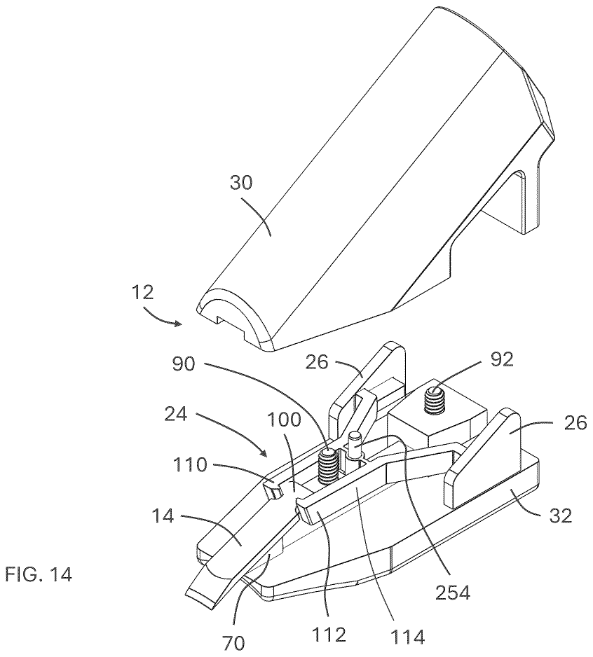

The blade holder 18 includes a blade retainer 24 (see FIG. 14) that releasably secures the blade 14 in the cleaning head 12. The blade retainer 24 includes one or more actuators, such as buttons 26, that may be pressed by a user to shift the blade retainer 24 to a disengaged or release configuration which permits removal and replacement of the blade 14. For example, the user may press the buttons 26 toward each other with the user's thumb and forefinger of one hand while, simultaneously, pulling the blade 14 out of the cleaning head 12 with their other hand.

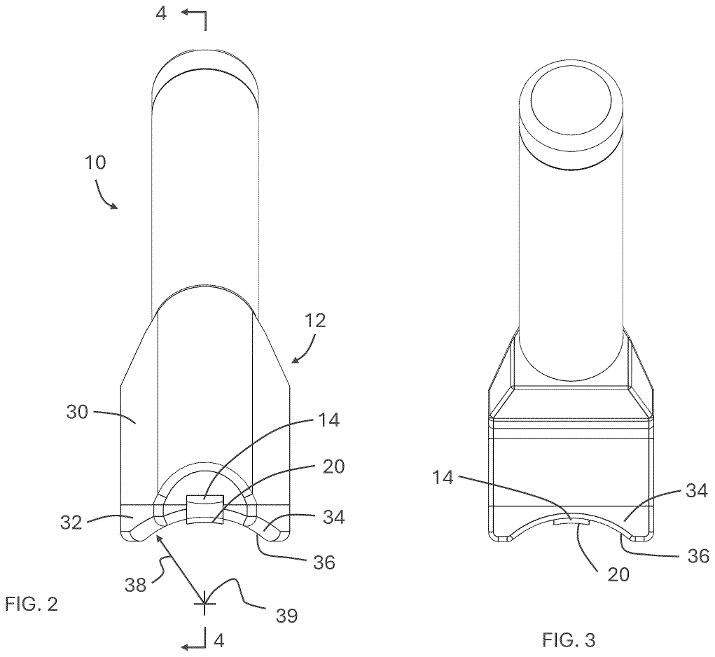

Regarding FIGS. 2 and 3, the cleaning head 12 has an upper portion 30 and a base or lower portion 32 configured to be engaged on a roller of a roller conveyor. The lower portion 32 has an arcuate saddle portion 34 with a concave surface 36 having a radius 38 from a central axis 39 of the arcuate saddle portion 34 that is sized to generally match the outer diameter of the roller. The central axis 39 of the arcuate saddle portion 34 is sized so as to be essentially coaxial with a central longitudinal axis of rotation of a roller when the arcuate saddle portion 34 is seated on the roller. For example, if the roller cleaning tool 10 is configured to remove stickers from a roller having 1.9 inch outer diameter, the radius 38 of the saddle portion concave surface 36 will be 0.95 inches. The saddle portion concave surface 36 and radius 38 thereof will be differently sized for different sized rollers, such as for a one inch or two inch diameter roller.

The scraping edge 20 of the blade 14 has a curvature with a radius 40 (see FIG. 6) that is smaller than the radius 38 of the saddle portion concave surface 36. The radius 40 of the blade scraping edge 20 is in the range of approximately 94% to approximately 96%, such as 95%, of the radius 38 of the saddle portion concave surface 36. For example, for a roller having the radius 38 of 0.95 inches, the radius 40 is 0.9 inches.

The roller cleaning tool 10, which includes the saddle concave surface 36 and the blade scraping edge 20, is configured to clean a particular size roller. More specifically, the radius 38 of the saddle portion concave surface 36 and the radius 40 of the blade scraping edge 20 for differently sized rollers are provided in the following table:

| Roller Outer | Saddle Concave | Blade Scraping |
|---|---|---|
| Radius | Surface Radius 38 | Edge Radius 40 |
| 0.75″ | 0.75″ | 0.7″ |
| 0.95″ | 0.95″ | 0.9″ |
| 1.5″ | 1.5″ | 1.425″ |
| 50 mm | 50 mm | 47.5 mm |

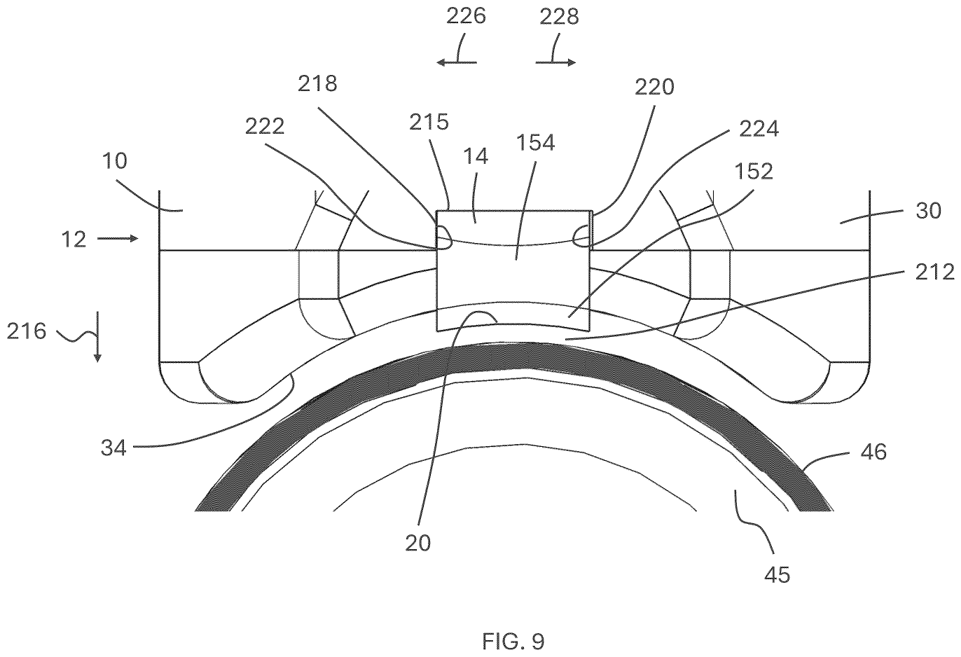

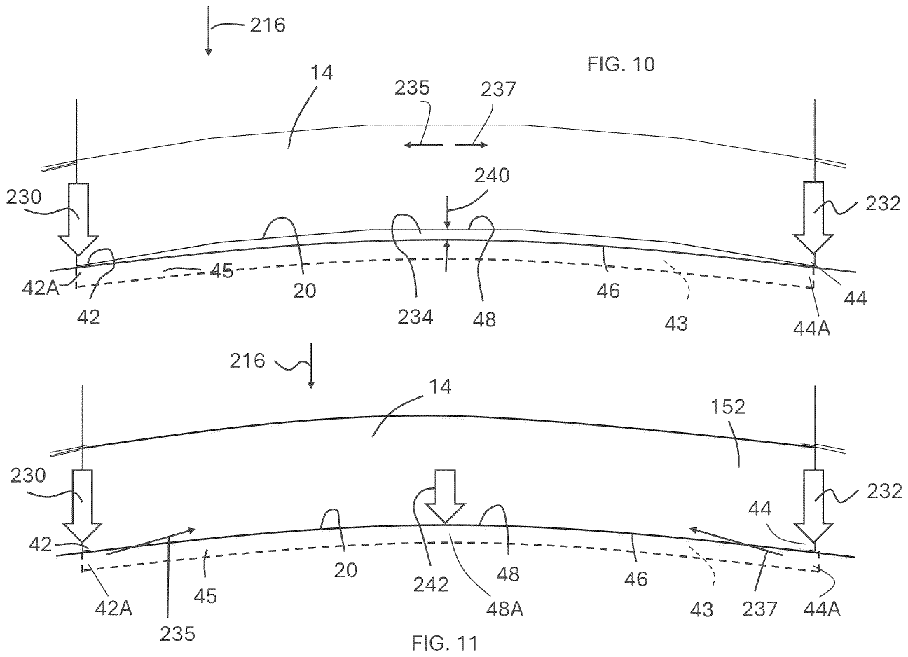

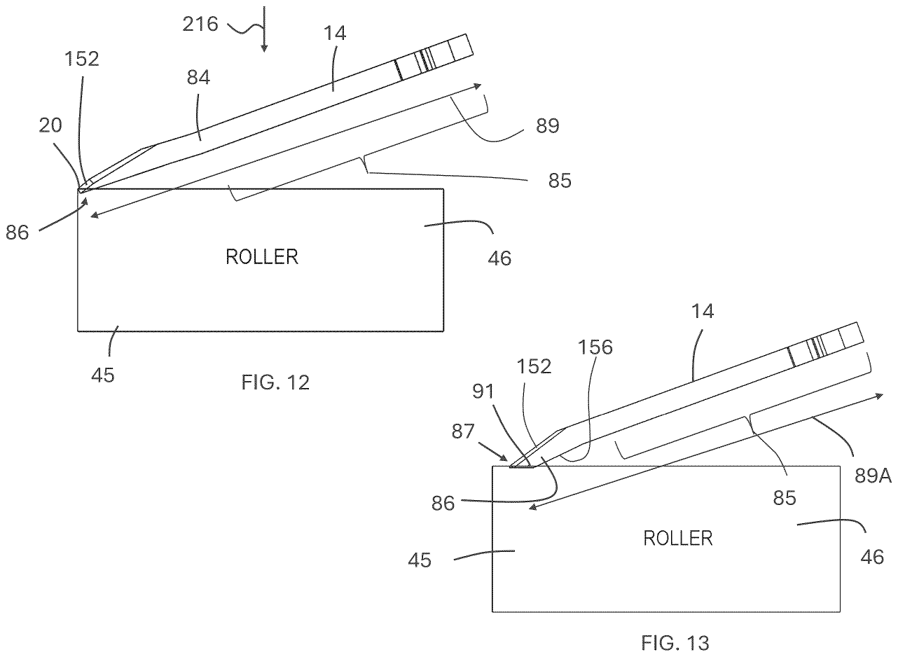

With reference to FIGS. 9 and 10, the smaller radius 40 causes outer corner portions 42, 44 of the scraping edge 20 to first contact a cylindrical outer surface 46 of the roller 45 when the roller cleaning tool 10 is initially lowered onto the roller 45. To fully engage the scraping edge 20 with the roller 45, the user presses the roller cleaning tool 10 downward in direction 216 (see FIG. 9) with a predetermined force, such as approximately 30 lbs, to deflect the blade 14 (see FIGS. 8 and 12) and seat the saddle portion concave surface 36 flush on the cylindrical outer surface 46 of the roller 45. The deflection of the blade 14 due to the downward force applied by the user pressing the roller cleaning tool 10 downward in direction 216 forms a bent portion 84 (see FIG. 12) in the blade 14 and shifts a center portion 48 of the scraping edge 20 between the outer corner portions 42, 44 into engagement with the roller 45. The bend in the bent portion 84 may be in the range of 1 degree to 5 degrees, as one example. Due to the smaller radius 40 of the scraping edge 20, the corner portions 42, 44 engage the cylindrical outer surface 46 with forces 230, 232 that are greater than a force 242 applied by the scraping edge center portion 48 against the cylindrical outer surface 46 when the user is pressing the roller cleaning tool 10 in direction 216.

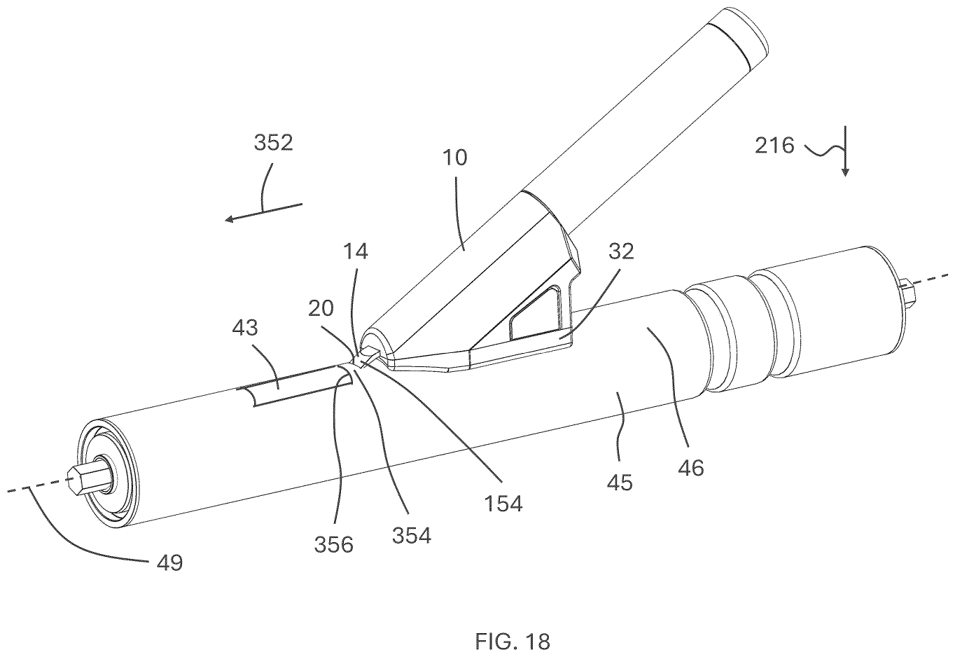

With the roller cleaning tool 10 fully seated against the roller 45 and aligned with the sticker 43 along the axis 49 of the roller 45 (see FIGS. 17 and 18), the user continues to press the roller cleaning tool 10 in direction 216 to keep the seat the saddle portion concave surface 36 flush on the cylindrical outer surface 46 of the roller 45, keep the blade 14 deflected, and keep the scraping edge 20 fully engaged with the roller cylindrical outer surface 46. The user then shifts the roller cleaning tool 10 in axial direction 352 (see FIG. 18) to scrape the sticker 43 off of the cylindrical outer surface 46 while continuing to press the roller cleaning tool 10 downward in direction 216 and causing the blade 14 to apply forces 230, 242, 232 against the roller cylindrical outer surface 46.

The scraping edge corner portions 42, 44 shear or scrape the sticker side portions 42A, 44A off of the roller cylindrical outer surface 46 while the scraping edge portion 48 lifts and tensions the sticker intermediate portion 48A to enhance the scraping by the scraping edge corner portions 42, 44. It has been found that tensioning the paper of the sticker 43 across the width of the sticker 43 (e.g., along the scraping edge 20) improves the initial wedging of the scraping edge corner portions 42, 44 beneath the paper of the sticker 43 and helps keep the scraping edge corner portions 42, 44 beneath the paper of the sticker 43 as the user shifts the roller cleaning tool 10 in axial direction 352 along the roller cylindrical outer surface 46.

More specifically, the scraping edge corner portions 42, 44 impart the large vertical forces 230, 232 against the roller cylindrical outer surface 46 due to the user continuing to press the tool 10 downward in direction 216 as the scraping edge 20 shifts in direction 352 along the roller cylindrical outer surface 46. The large vertical forces 230, 232 drive the scraping edge corner portions 42, 44 under the paper of the sticker 43 and keep the scraping edge corner portions 42, 44 under the paper of the sticker 43 as the user shifts the roller cleaning tool 10 in direction 352 parallel to the central rotational axis 49 of the roller 45. The scraping edge corner portions 42, 44 are thereby able to wedge or peel opposite side portions 42A, 44A of the sticker 43 off of the roller cylindrical surface 46 as the user shifts the roller cleaning tool 10 in direction 352 along the roller cylindrical outer surface 46.

Further, the vertical force 242 of the scraping edge center portion 48 against the roller cylindrical outer surface 46 enables the scraping edge center portion 48 to get under and stay under the paper of the sticker intermediate portion 48A as the user presses the tool 10 in direction 216 and shifts the tool in direction 352 along the roller 45. The paper of the sticker 43 at the intermediate portion 48A of the sticker 43 tends to travel up proximally (into the page of FIG. 11) along a tapered edge surface 152 of the blade 14 as the scraping edge center portion 48 wedges underneath the sticker paper at the sticker intermediate portion 48A. The slight movement of the paper of the sticker intermediate portion 48A proximally up the tapered edge surface 152 lifts or pulls the paper of the sticker intermediate portion 48A upwardly away from the roller cylindrical outer surface 46. The lifting or pulling of the sticker intermediate portion 48A tensions the paper of the sticker across the width of the sticker in FIG. 11 and pulls the sticker side portions 42A, 44A in directions 235, 237 away from the roller cylindrical outer surface 46, which assists in keeping the scraping edge corner portions 42, 44 scraping under the paper of the sticker and separating the sticker from the outer cylindrical surface 46.

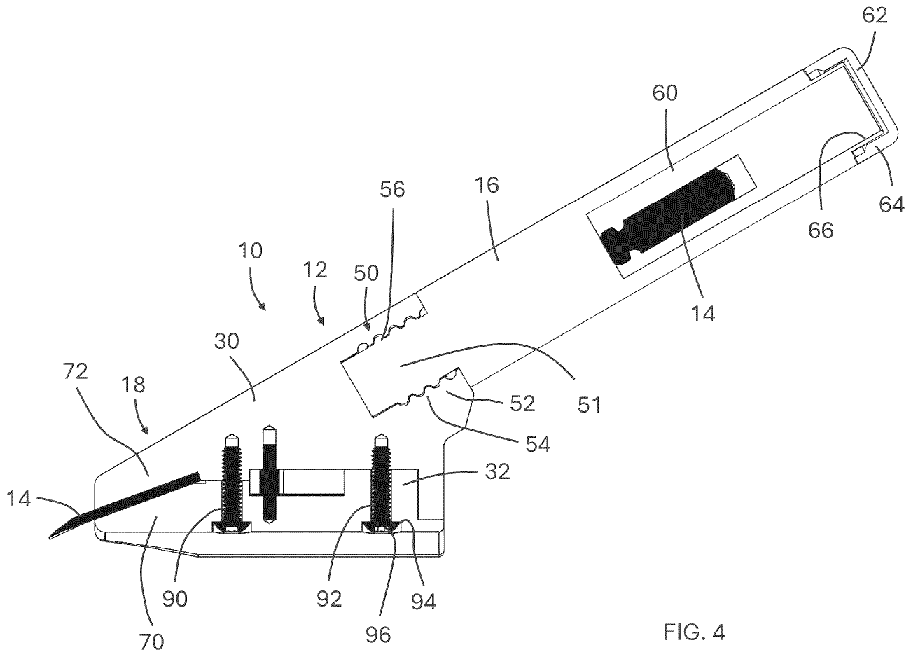

Regarding FIG. 4, the roller cleaning tool 10 has a releasable connection 50 between the cleaning head 12 and the handle 16. In one embodiment, the cleaning head 12 includes a handle socket 52 with female threads 54 that engage male threads 56 of a threaded plug portion 51 of the handle 16. The threaded plug portion 51 is sized the same as that of threaded plug portions of standard broom handles so that the handle 16 may be removed from the cleaning head 12 and may be replaced with a standard threaded broom handle for a longer reach. In this manner, the handle 16 may be used when the user is able to get close to the sticker on the roller and a broom handle may be used when the sticker is farther away from the user on the roller, such as when a user is on a nearby platform. The handle 16 includes a compartment 60 at its proximal end portion for storing additional blades 14 such that the blade 14 may be replaced as the blade 14 wears down. The handle 16 has an end cap 62 with female threads 64 that engage male threads 66 of a proximal wall portion of the handle extending about the compartment 60. In this manner, the cap 62 may be removed to permit access to the compartment 60 and the blades 14 stored therein.

The blade holder 18 includes a lower inclined blade support 70 of the lower portion 32 that cooperates with an upper inclined blade support 72 of the upper portion 30 to orient the blade 14 to extend at an oblique angle 80 (see FIG. 8), such as 20°, relative to an axis 82 extending parallel to the roller rotary or longitudinal axis 49 when the roller cleaning tool 10 is positioned to extend generally parallel to the roller 45. The blade holder 18 orients a held or captured portion 85 of the blade 14 to extend at the angle 80 regardless of whether the blade 14 is new or worn down. As an example, the worn blade 14 in FIG. 13 may be representative of the blade 14 after the roller cleaning tool 10 has been used to remove approximately fifty stickers.

Regarding FIG. 12, when the blade 14 is new, the distal tip portion 86 of the blade 14 extends downwardly and distally farther than the distance between the blade holder 18 and the roller 45 such that there is an interference between the distal tip portion 86 and the cylindrical outer surface 46 of the roller 45. When the blade 14 is new, the distal tip portion 86 is generally formed by the upper and lower tapered edge surfaces 152, 156 and the scraping edge 20. The scraping edge 20 is a juncture between the upper and lower tapered edge surfaces 152, 156.

The interference between the distal tip portion 86 and the roller cylindrical outer surface 46 forms a bent portion 84 in the blade 14 when the user is pressing the roller cleaning tool 10 in forward and downward direction 216 against the roller 45. The distal tip portion 86 includes the scraping edge 20 and, as shown in FIG. 12, the scraping edge 20 engages the cylindrical outer surface 46 of the roller 45.

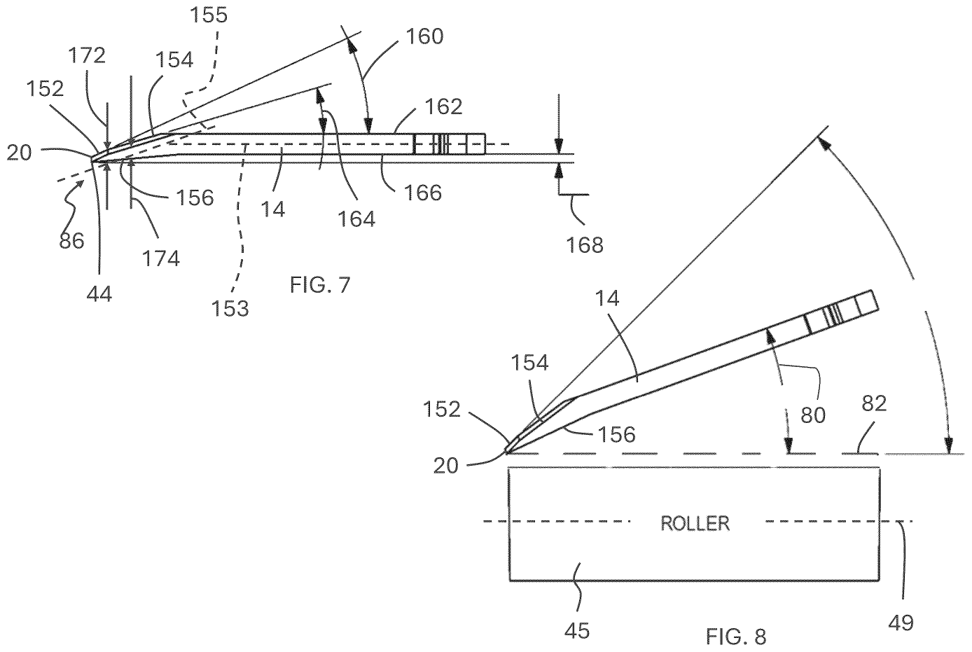

FIG. 13 shows the blade 14 after the distal tip portion 86 has been worn down. The remaining distal tip portion 86 has an edge 87 engaged flush with the roller cylindrical outer surface 46. The edge 87 has been dulled relative to the appearance of new or undulled edge 20 in FIGS. 7, 8. The edge 87 includes an arcuate surface 91 facing the roller cylindrical surface 46 that connects the distal ends of tapered edge surface 152 and tapered lower edge surface 156. The tapered lower edge surface 156 has a cylindrical shape to substantially match the curvature of the roller cylindrical outer surface 46. Further, the arcuate surface 91 of the edge 87 has a curvature that matches the curvature of the roller cylindrical outer surface 46.

Due to the distal tip portion 86 wearing down, the worn blade 14 has a shorter overall length 89A than a length 89 of the new blade 14, which produces less interference between the distal tip portion 86 when the blade 14 is worn (FIG. 13) than when the blade 14 is new (FIG. 12). The shorter, worn blade 14 is generally straight and so does not have the bent portion 84 since there is less interference between the distal tip portion 86 and the roller cylindrical outer surface 46. The ability of the blade 14 to deflect when new, while deflecting less when worn, extends the lifespan of the blade 14 because the blade 14 can wear down a distance along the length 89 of the blade 14 that is greater than if the blade 14 were completely straight when new and engaged with the roller 45. In other words, the ability of the new blade 14 to deflect when engaged with the roller 45 takes up some of the material of the new blade 14 that is subsequently consumed as the blade 14 wears down.

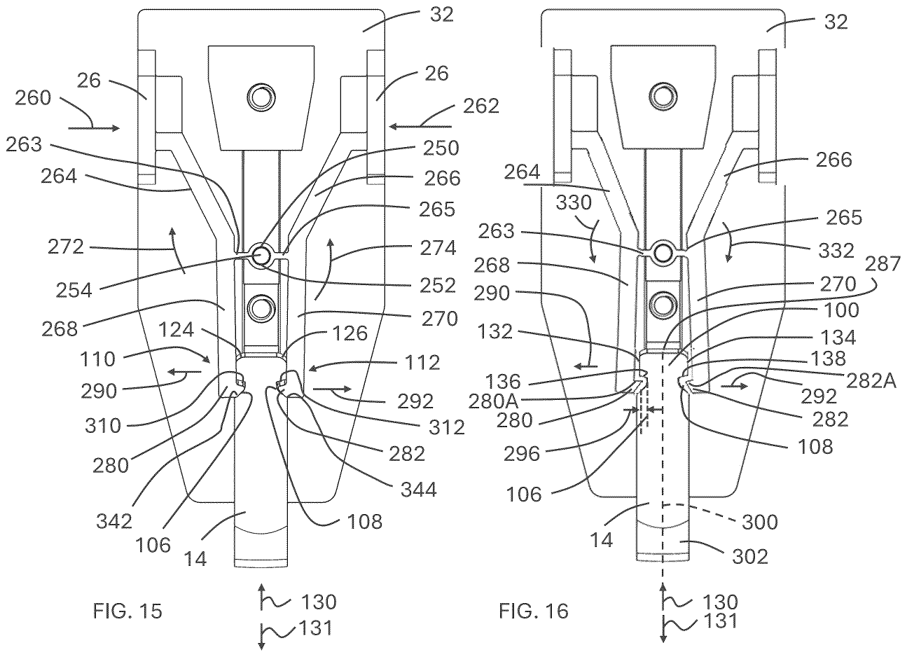

Returning to FIG. 4, the cleaning head 12 includes fasteners such as bolts 90, 92 for securing the upper portion 30 and lower base portion 32 together. When the bolts 90, 92 are tightened down, the upper and lower inclined blade supports 70, 72 press the blade 14 therebetween to provide resistance to movement of blade 14 in proximal and distal directions 130, 131 (see FIG. 15) while still permitting a user to manually remove a used blade 14 from the blade holder 18 in distal direction 131 and load a new blade 14 into the blade holder 18 in proximal direction 130. The lower portion 32 has countersunk openings 94 that receive head portions 96 of the bolts 90, 92 to keep the head portions 96 clear of the roller cylindrical outer surface 46 when the saddle portion 34 is seated in engagement on the roller 45.

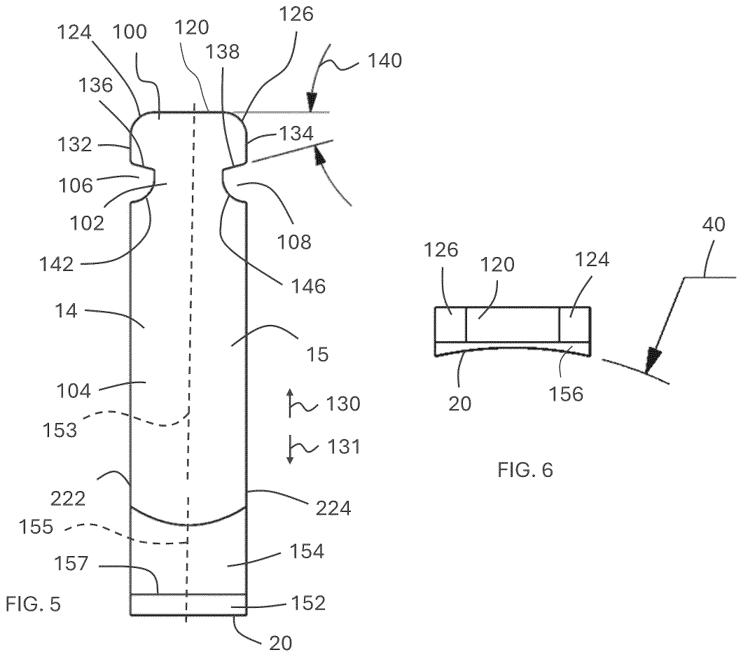

Regarding FIG. 5, the blade 14 has a head portion 100, a neck portion 102, and an elongate shank portion 104. The blade 14 has recesses 106, 108 on opposite lateral sides of the blade 14 at the neck portion 102 to receive gripping portions 110, 112 (see FIG. 14) of a resilient member 114 of the blade retainer 24 that secure the blade 14 in the cleaning head 12. As shown in FIG. 5, the head portion 100 has a trailing end surface 120 extending between trailing curved corner surfaces 124, 126 that are configured to urge the gripping portions 110, 112 apart when the blade 14 is advanced in proximal direction 130 into the blade holder 18. The head portion 110 has side surfaces 132, 134 that the gripping portions 110, 112 slide along until reaching the recesses 106, 108 as the blade 14 is advanced in proximal direction 130 into the blade holder 18. The gripping portions 110, 112 of the blade retainer 24 snap into the recesses 106, 108 and secure the blade 14 in the cleaning head 12 once the blade 14 has been fully advanced in proximal direction 130 into the blade holder 18.

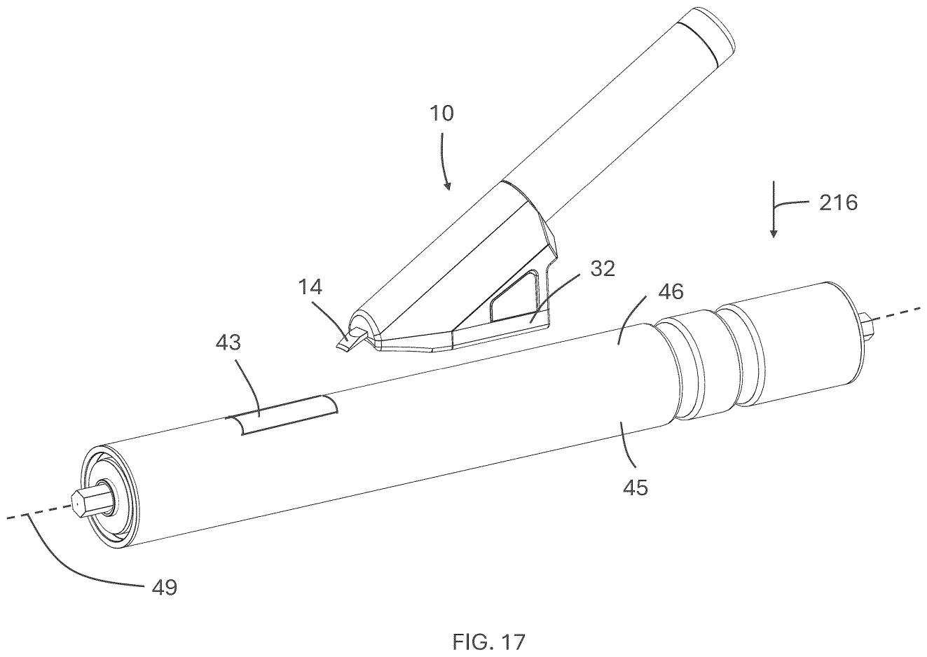

The recesses 106, 108 have slightly tapered flat retaining surfaces 136, 138 that each extend at an oblique angle 140, such as 15 degrees, relative to the trailing end surface 120, and form the underside of the head portion 100. The slight taper of the flat retaining surfaces 136, 138 keep the gripping portions 110, 112 in the recesses 106, 108 even if the blade 14 is subjected to light forces in the distal direction 131 such as can be generated when the blade 14 may be temporarily stuck in adhesive on the roller and the user pulls back on the tool to free the blade 14. The tapered retaining surfaces 136, 138 are further configured to urge or cam the gripping portions 110, 112 apart as the blade 14 is removed and pulled from the cleaning head 12 in distal direction 131. Specifically, when the user wants to replace the blade 14, the user presses the buttons 26 together to shift the gripping portions 110 apart. As shown in FIG. 16, the gripping portions 110, 112 have a predetermined amount of interference with the head portion 100 even when the buttons 26 have been fully pressed to limit the blade 14 from unintentionally falling out of the blade holder 18 in distal direction 131. Instead, the user presses the buttons 26, grasps the blade 14, and pulls the blade 14 out of the blade holder 18 in distal direction 131. The tapered retaining surfaces 136, 138 of the blade head portion 100 cam the gripping portions 110, 112 apart farther apart so that the gripping portions have a space therebetween sized to permit the head portion 100 to fit and travel between the gripping portions 110, 112 in distal direction 131. The neck portion 102 includes arcuate recessed surfaces 142, 146 of the recesses 106, 108 that provide clearance for the gripping portions 110, 112 to be received in the recesses 106, 108.

Regarding FIG. 7, the distal tip portion 86 that includes the scraping edge 20, a tapered edge surface 152, a tapered lead-in surface 154, and a tapered lower edge surface 156. The tapered edge surface 152 extends at an angle 160 relative to a flat, upper surface 162 of the blade 14 while the tapered lead-in surface 154 extends at a smaller angle 164 relative to the upper surface 162. In one embodiment, the angle 160 is 25 degrees and the angle 164 is 17 degrees. The tapered lower edge surface 156 extends downwardly and distally from a flat, lower surface 166 of the blade 14 to join the tapered edge surface 152 and form the scraping edge 20 below the lower surface 166.

With reference to FIG. 5 the shank portion 104 has a central axis 153 and the distal tip portion 86 has a central axis 155. The central axes 153, 155 extend obliquely to one another as shown in FIG. 7. The upper tapered edge surface 152 has a convex, cylindrical shape and the tapered lower edge surface 156 has a concave, cylindrical shape that curve around respective axes that are inclined relative to one another.

The corner portions 42, 44 of the scraping edge 20 are positioned a distance 168, such as 0.034 inches, below the bottom surface 166. The tapered edge surface 152 and tapered lower edge surface 156 provide a first thickness 172 of the distal tip portion 86 adjacent the scraping edge 20 that is thinner than a second thickness 174 of the distal tip portion 86 between the tapered lead-in surface 154 and the tapered lower edge surface 156. The reduced thickness 172 provides flexibility adjacent the scraping edge 20 when the blade 14 is new. As the blade 14 wears, the distal tip portion 86 bends less because of the material of the blade 14 wearing away as discussed above. The larger thickness 174 permits the blade 14 to remain in contact with the roller despite the loss of material of the blade 14 due to the blade 14 wearing down. This is shown by the distal tip portion 86 being in contact with the roller 45 in FIG. 12 when the blade 14 is new and being in contact with the roller 45 in FIG. 13 when the blade 14 is worn. In FIG. 13, the scraping edge 20, proximal edge surface 152, and a distal portion of the tapered lower edge surface 156 have worn away such that the distal tip portion 86 is worn but continues to engage the roller 45.

Regarding FIG. 5, the blade 14 has a juncture 157 between the tapered lead-in surface 154 and the tapered edge surface 152. When the distal tip portion 86 has worn down to the juncture 157, a user can visually identify that the blade 14 should be replaced.

Regarding FIG. 9, the roller cleaning tool 10 is shown positioned above the roller 45 with a spacing 212 between the scraping edge 20 and a cylindrical outer surface 46 of the roller 45. The cleaner head 12 has a slot 215 that receives the blade 14. The slot 215 has side support surfaces 218, 220 that abut side surfaces 222, 224 of the blade 14 and resist movement of the blade 14 in lateral directions 226, 228. The roller cleaning tool 10 is shown in FIG. 9 before being shifted downwardly in direction 216 and seating the saddle portion 34 on the cylindrical outer surface 46. Seating the saddle portion 34 on the cylindrical outer surface 46 deflects the blade 14 from the initial, undeflected configuration of FIGS. 8 and 9 to the deflected configuration of FIGS. 11, 12 where the blade 14 has a bent portion 84.

Turning to FIGS. 10 and 11, the user is positioning the roller cleaning tool 10 on the roller 45 and is urging the corner portions 42, 44 against the roller cylindrical outer surface 46 with forces 230. Due to the radius 40 of the scraping edge 20 being smaller than the radius of the cylindrical outer surface 46, there is initially a spacing 234 between the center portion 48 of the scraping edge 20 and the roller cylindrical outer surface 46. The spacing 234 provides an initial distance 240 between the scraping edge center portion 48 and the roller cylindrical outer surface 46.

As part of seating the roller cleaning tool 10 on the roller 45, the user applies additional force against the roller cleaning tool 10 in direction 216 to deflect the blade 14 and engage the center portion 48 of the scraping edge 20 with the roller cylindrical outer surface 46. The deflection of the blade 14 includes forming the bent portion 84 (see FIG. 12) in the blade 14 and urging the corner portions 42, 44 apart in directions 235, 237 to shift the scraping edge center portion 48 in direction 216 against the roller cylindrical outer surface 46.

When the user is urging the roller cleaning tool 10 in direction 216 with enough force to fully engage the scraping edge 20 with the roller cylindrical outer surface 46, the corner portions 42, 44 of the scraping edge 20 apply forces 230, 232 against the roller cylindrical outer surface 46 that are greater than the force 242 the center portion 48 of the scraping edge 20 applies against the roller cylindrical outer surface 46. The center portion 48 applies the smaller force 242 because the center portion 48 is initially recessed vertically above the corner portions 42, 44 (as shown in FIG. 10) and deflects into contact with the cylindrical outer surface 46 via slight shifting apart of the corner portions 42, 44 in directions 235, 237 as the user presses the roller cleaning tool 10 in direction 216 against the roller 45. By contrast, the corner portions 42, 44 extend lower than the center portion 48 (as shown in FIG. 10) to have a tighter engagement with the roller 45 and transfer the majority of the load between the blade 14 and the roller 45.

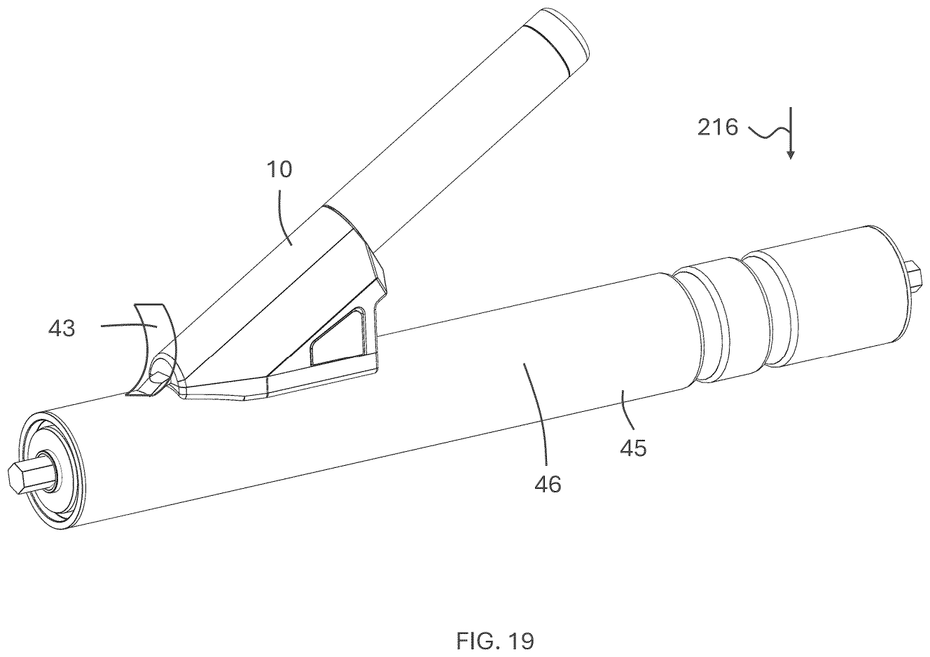

In this manner, the force profile of the scraping edge 20 against the roller cylindrical outer surface 46 has peaks, or is concentrated at, the corner portions 42, 44 but is also present at the center portion 48 of the scraping edge 20. The higher forces 230, 232 enable the corner portions 42, 44 to pierce and get under a sticker on the roller cylindrical outer surface 46 while the center portion applies tension across the sticker between the corner portions 42, 44 and wedges the sticker away from the roller cylindrical outer surface 46. The scraping edge 20 may thereby scrape underneath and lift a sticker for the entire width of the scraping edge 20, which produces wide sections of peeled off stickers (see FIG. 19).

Regarding FIGS. 14 and 15, the gripping portions 110, 112 of the blade retainer 24 engage the head portion 100 and keep the blade 14 in position along the inclined blade support 70. The blade retainer 24 has an opening 250 and a circular wall portion 252 extending thereabout. The opening 250 receives an alignment pin 254 that keeps the blade retainer 24 in position on the lower portion 32. The blade retainer 24 includes resilient portions 263, 265 extending from the circular wall portion 252. The resilient member 114 of the blade retainer 24 has connector portions 264, 266 and arm portions 268, 270 extending away from the thin wall portions 263, 265. The connector portions 264, 266 connect the buttons 26 to the arm portions 268, 270. The arm portions 268, 270 space the gripping portions 110, 112 away from the resilient portions 263, 265. In one embodiment, the resilient member 114 of the blade retainer 24 has a unitary, one-piece construction and may be made of, for example, a plastic material.

Regarding FIGS. 15 and 16, to remove a worn blade 14 from the cleaning head 12, a user presses the buttons 26 together in directions 260, 262 which pivots the connecting portions 264, 266 and arm portions 268, 270 in directions 272, 274 about the alignment pin 254. The gripping portions 110, 112 have protrusions such as barbs 280, 282 that extend into the recesses 106, 108 of the blade 14. The pivoting of the arm portions 268, 270 in directions 272, 274 shifts the barbs 280, 282 partially out of the recesses 106, 108 in directions 290, 292. The resilient portions 263, 265 deflect to accommodate the pivotal movement of the arm portions 268, 270 and disengagement of the barbs 280, 282 from the blade 14.

Regarding FIG. 16, the barbs 280, 282 still extend laterally into the recesses 106, 108 a distance 296 as measured from the side surfaces 132, 134 of the blade head portion 100. This overlap along a central longitudinal axis 300 of the blade 14 keeps the blade 14 from freely sliding out of the blade holder 18 when the buttons 26 have been pressed. To remove the blade 14 from the blade holder 18, a user grasps a distal end portion 302 of the blade 14 and pulls the blade 14 in the distal direction 131. The movement of the blade head portion 100 in direction 131 cammingly engages the tapered retaining surfaces 136, 138 with inclined retaining surfaces 310, 312 (see FIG. 15) of the barbs 280, 282. The camming engagement between the blade head tapered retaining surfaces 136, 138 and the barb inclined retaining surfaces 310, 312 urges the barbs farther in directions 290, 292 to a fully open configuration wherein the blade head portion 100 may advance distally beyond the barbs 280, 282 and slide out of the blade holder 18 in direction 131.

Regarding FIG. 16, once the worn blade 14 has been removed in direction 131, the resilient portions 263, 265 unload and pivot the connector portions 264, 266 and arm portions 268, 270 back in directions 330, 332 and back to an initial, retaining position similar to the configuration of FIG. 15.

Regarding FIG. 15, to connect a new blade 14 to the cleaning head 12, a user advances the blade 14 in direction 130 into the blade holder 18. The user continues to advance the blade 14 in direction 130 until the tapered trailing surfaces 124, 126 of the blade head portion 100 cammingly engage inclined leading surfaces 342, 344 of the barbs 280, 282. The camming engagement between the tapered trailing surfaces 124, 126, and barb inclined surfaces 342, 344 expands apart the arm portions 268, 270 and increases the distance between the barbs 280, 282 such that the head portion 100 may advance beyond the barbs 280, 282 in direction 130. The user continues to advance the blade 14 in direction 130 until the side recesses 106, 108 of the blade 14 align with the barbs 280, 282. At this point, the resilient portions 263, 265 resiliently bias the arm portions 268, 270 in directions 330, 332 (see FIG. 16) which urges the barbs 280, 282 together and snaps the barbs 280, 282 into the recesses 106, 108 of the new blade 14. The barbs 280, 282 have return surfaces 280A, 282A with a slight incline, such as 10 degrees, that engage the tapered retaining surfaces 136, 138 of the blade head portion 100 as the barbs 280, 282 snap into the recesses 106, 108 of the new blade 14. The return surfaces 280A, 282A urge the blade head portion 100 in direction 130 against a blade seat 287 of the lower portion 32 and inhibit rattling of the blade 14 in the blade holder 18.

Regarding FIGS. 17-19, the method of removing the sticker 43 with the roller cleaning tool 10 is shown. Regarding FIG. 17, the roller cleaning tool 10 is positioned above the roller 45 and lowered in direction 216 to seat the lower portion 32 of the roller cleaning tool 10 on the cylindrical outer surface 46 of the roller 45.

Regarding FIG. 18, the roller cleaning tool 10 is positioned along the roller 45 in FIG. 18 so that the scraping edge 20 has a spacing 354 from the sticker 43 and the scraping edge 20 is laterally aligned with the sticker 43. Laterally is used herein to refer to along a length of the roller 45 whereas longitudinal refers to a direction of movement of objects along the conveyor that includes the roller 45. This permits the scraping edge 20 to engage and go underneath of a peripheral edge 356 of the sticker 43 to start peeling off the sticker 43 from the cylindrical outer surface 46.

Regarding FIGS. 18 and 19, the roller cleaning tool 10 is shifted in direction 352 to advance the scraping edge 20 along the roller 45 and peel the sticker 43 from the cylindrical outer surface 46. The lead-in surface 154 of the blade 14 operates as a wedge to lift and bend the sticker 43 away from the cylindrical outer surface 46 of the roller 45. This further contributes to the removal of a wide sticker section having a width that matches the width of the scraping edge 20 rather than a narrow scraping cut in the sticker 43. In this manner, the roller cleaning tool 10 is able to remove wide sections of the sticker 43 with each pass of the roller cleaning tool 10 in direction 352 along the sticker 43. In some situations, after scraping off the sticker 43 with the roller cleaning tool 10, a user may wipe down the roller cylindrical outer surface 46 with water or an adhesive removing solvent on a cloth to remove any adhesive left behind on the roller cylindrical outer surface 46.

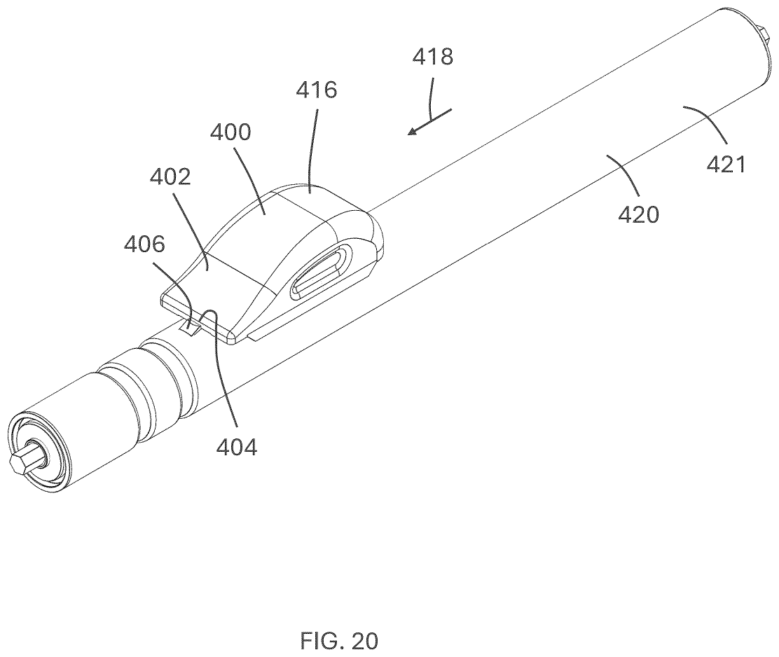

Regarding FIG. 20, a roller cleaning tool 400 is provided that is similar in many respects to the roller cleaning tool 10 discussed above. The roller cleaning tool 400 has a cleaning head, such as a body 402, with a blade holder 404 that receives a blade 406 having a tip portion 411 (see FIG. 22) including a scraping edge 412 that is similar to the blade 14 discussed above. The roller cleaning tool 400 has a handle portion 416 that a user grasps and uses to shift the roller cleaning tool 400 in direction 418 along a roller 420 to remove a sticker therefrom.

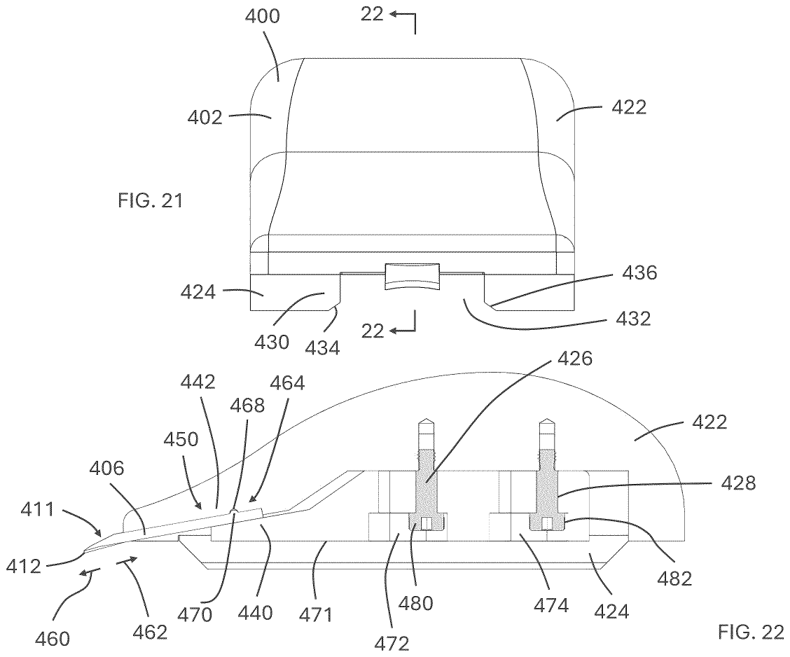

Regarding FIGS. 20 and 21, the body 402 includes an upper portion 422 and a lower portion 424 that are releasably connected via fasteners such as bolts 426, 428. The lower portion 424 has an arcuate saddle portion 430 with a channel 432 to receive a roller 420 and tapered surface portions 434, 436 that compliment a cylindrical outer surface 421 of the roller 420.

Regarding FIG. 22, the lower portion 424 includes an inclined blade support portion 440 that orients the blade 406 at an angle relative to the roller 420 in a manner similar to the inclined blade support 70 of the roller cleaning tool 10. The upper portion 422 likewise has an inclined blade support portion 442 to support an upper surface of the blade 406. The roller cleaning tool 400 includes clamping portions 450 of the body 402 that tightly secure the blade 406 therebetween. In one embodiment, the clamping portions 450 include the inclined blade support portions 440, 442. To inhibit movement of the blade 406 in fore/aft directions 460, 462, the blade 406 and body 402 have interlocking portions 464 such as a recess 468 of the upper portion 422 and a protrusion 470 of the blade 406. To remove a worn blade 406 from the roller cleaning tool 400, the bolts 426, 428 are loosened to permit the user to separate the lower portion 424 from the upper portion 422 and remove the blade 406. The user may then load a new blade 406 between the upper portion 422 and lower portion 424, align the recess 468 and protrusion 470, and tighten down the bolts 426, 428 to secure the blade 406 in the roller cleaning tool 400.

Regarding FIG. 22, the channel 432 has an upper surface 471 and the lower portion 424 has countersink openings such as recesses 472, 474 in the channel upper surface 471 to receive heads 480, 482 of the bolts 426, 428. In this manner, the heads 480, 482 are recessed from the channel upper surface 471 and are kept from interfering with sliding movement of the roller cleaning tool 400 along the roller 420 during a sticker removing operation.

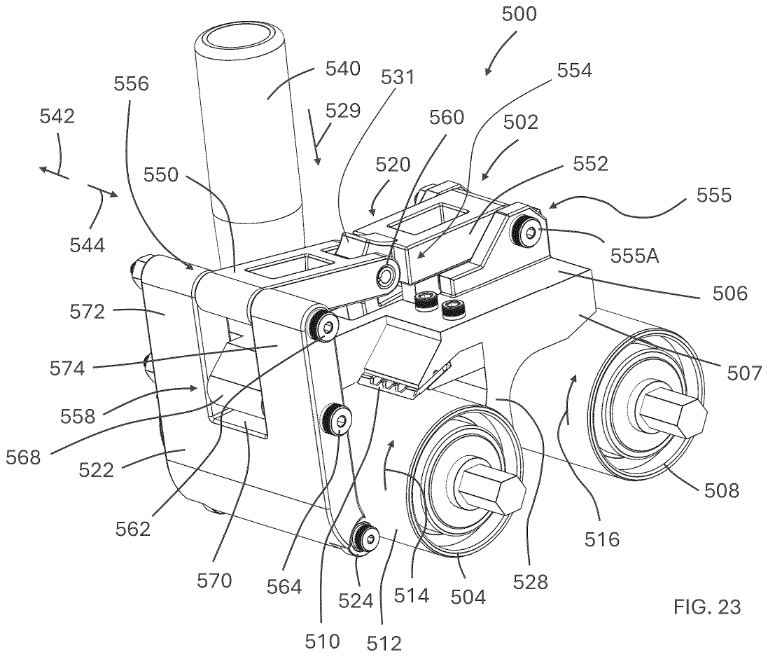

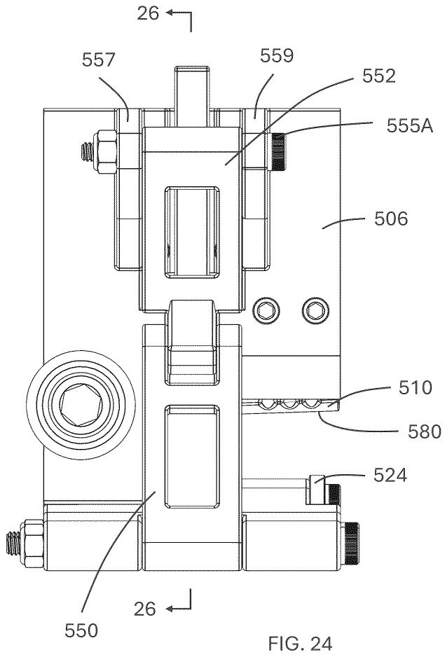

Regarding FIG. 23, a roller cleaning tool 500 is provided having a roller clamp 502 to secure the roller cleaning tool 500 to a roller 504 and a body 506 to seat upon a downstream roller 508. The body 506 has a contact portion 507, such as a tapered surface, to be slidably supported on the downstream roller 508 as the downstream roller 508 rotates.

The roller cleaning tool 500 has a blade 510 that engages a cylindrical outer surface 512 of the roller 504 to remove a sticker therefrom as the rollers 504, 508 are driven in directions 514, 516 by drive bands or other drive members of the roller conveyor that includes the rollers 504, 508.

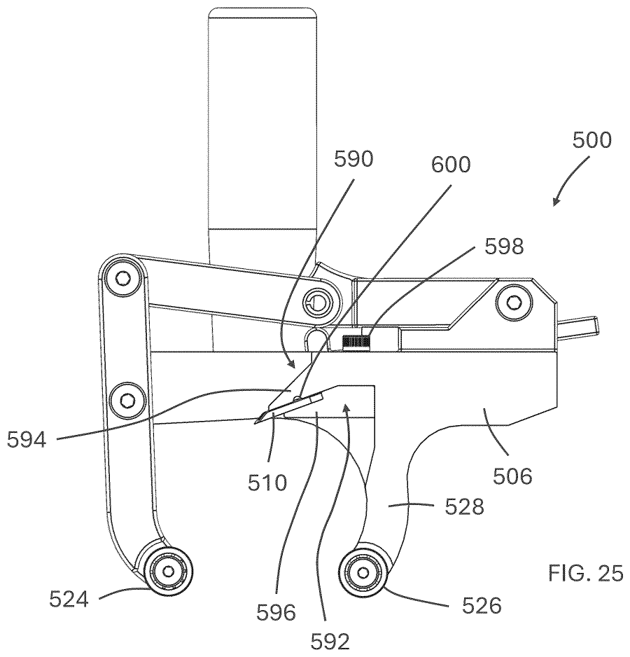

The roller clamp 502 has an engaged configuration (see FIG. 23) wherein an over-center linkage 520 of the roller clamp 502 positions a pivotal roller clamp member 522 so that wheels 524 thereof tightly engage an opposite side of the roller 504 from wheels 526 (see FIG. 25) of a fixed leg portion 528 of the body 506. The wheels 524, 526 clamp the roller 504 therebetween while permitting rotation of the roller 504 relative to the roller clamp member 522 and leg portion 528.

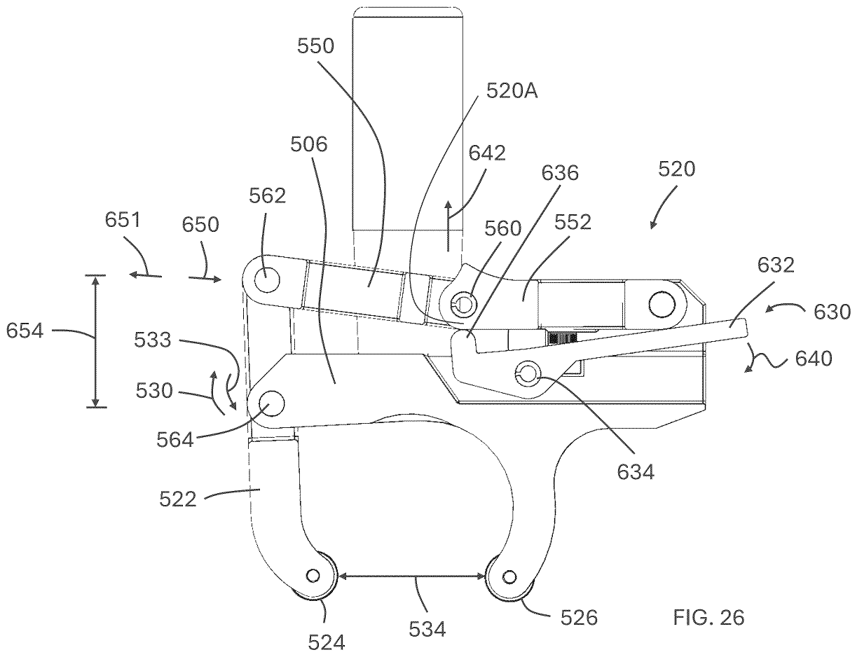

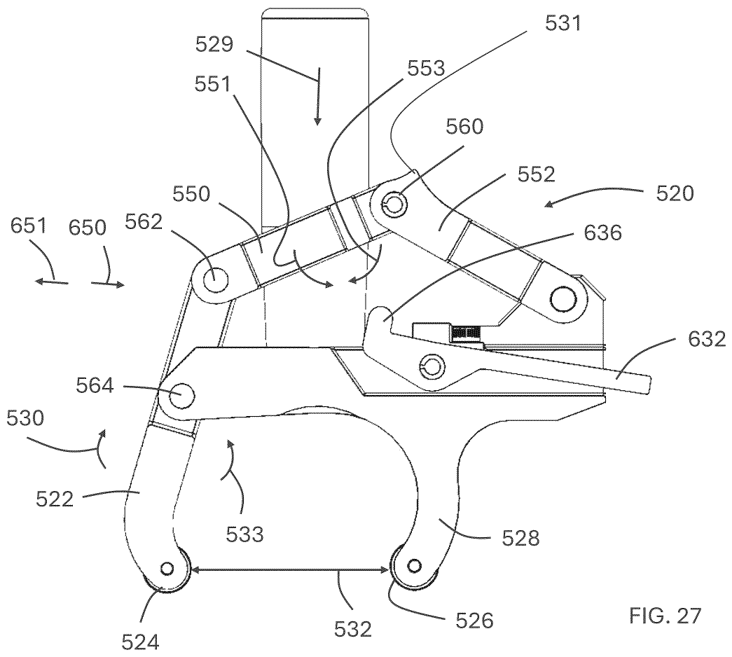

The roller clamp 502 has a disengaged or released configuration as shown in FIG. 27 wherein the roller clamp member 522 is pivoted in direction 530 away from the fixed leg portion 528 to provide a distance 532 between the wheels 524, 526 that is larger than a distance 534 (see FIG. 26) when the roller clamp member 522 is in the engaged configuration. The distance 532 is larger than an outer diameter of the roller 504 to permit the roller cleaning tool 500 to be positioned on, or removed from, the roller 504 when the roller clamp 502 is in the disengaged configuration thereof.

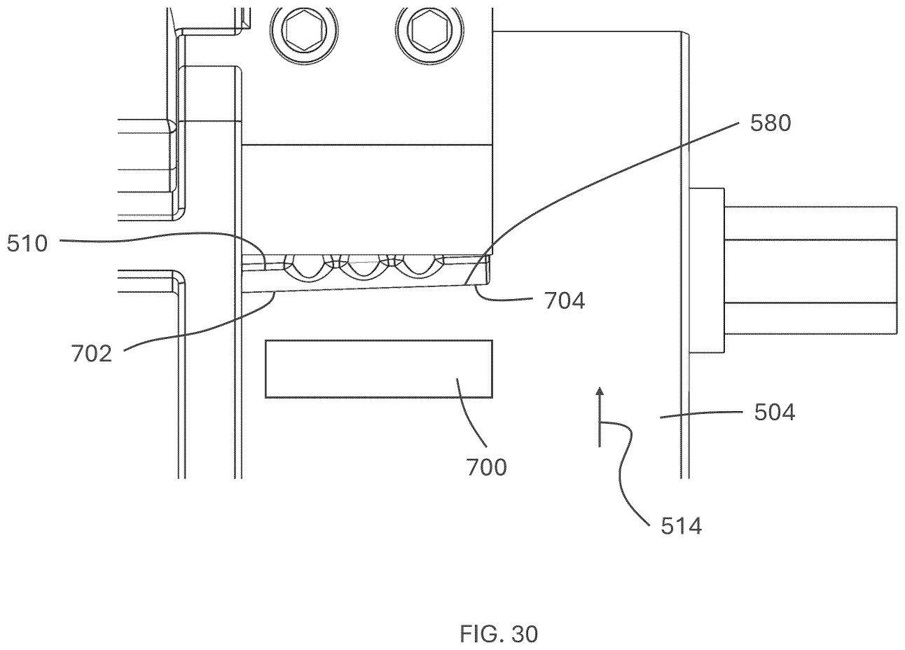

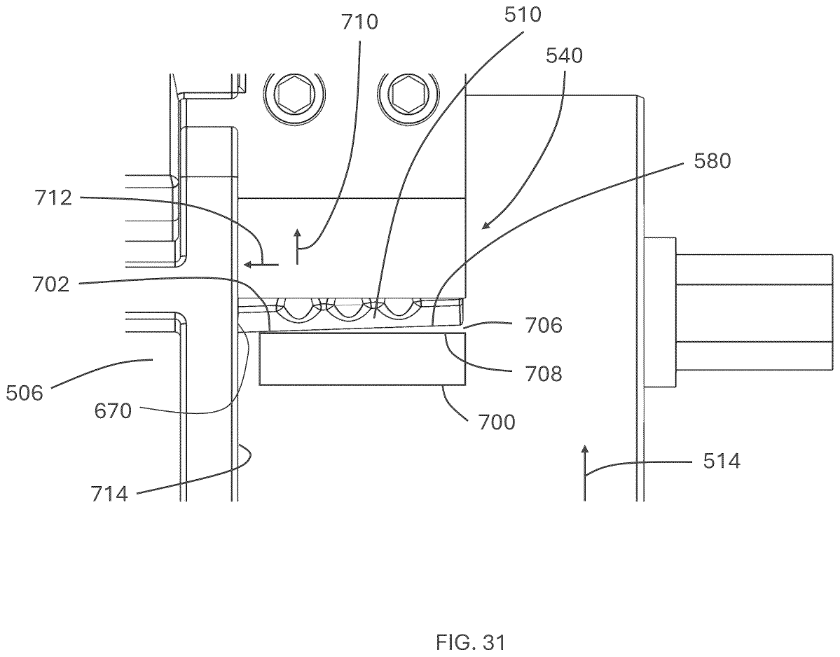

Returning to FIG. 23, the roller cleaning tool 500 has a handle 540 connected to the body 506 for shifting the roller cleaning tool 500 laterally in directions 542, 544 when the roller clamp 502 is in the disengaged configuration. Specifically, a user positions the roller cleaning tool 500 onto the roller 504 and uses the handle 540 to push or pull the roller cleaning tool 500 in directions 542, 544 along the roller 504 until the blade 510 is longitudinally aligned with a sticker 700 (see FIG. 30). Next, the user presses in direction 529 on an actuator 531 of the over-center linkage 520 to pivot the roller clamp member 522 in direction 533 (see FIG. 27) into engagement with the roller 504. The roller cleaning tool 500 tightly holds the roller 504 between the wheels 524, 526 which secures the roller cleaning tool 500 in position along the roller 504. The user's pressing the actuator 531 in direction 533 pivots links 550, 552 of the over-center linkage 520 to an over-center configuration that rigidly inhibits pivoting of the roller clamp member 522 in direction 530 until the user lifts a release lever 632 of a clamp release actuator 630 of the roller cleaning tool 500. Next, the roller 504 is rotated in direction 514 to rotate the sticker 700 into engagement with the blade 510 as shown in FIGS. 30 and 31.

Regarding FIG. 23, the links 550, 552 of the over-center linkage 520 are connected via a pivot connection 554. The link 550 is likewise connected to the roller clamp member 522 via a pivot connection 556. The roller clamp member 522 has a pivot connection 558 with the body 506 that permits pivotal movement of the roller clamp member 522. The link 552 has a pivotal connection 555 with supports 557, 559 fixed to the body 506. In one embodiment, the pivot connections 554, 555, 556, 558 include a spring pin 560 and bolts 562, 564, 555A. The body 506 has a projecting portion 568 extending into an opening 570 of the roller clamp member 522. The roller clamp member 522 has pivot arm portions 572, 574 extending along opposite sides of the opening 570 for connecting to the link 550 at the pivot connection 556.

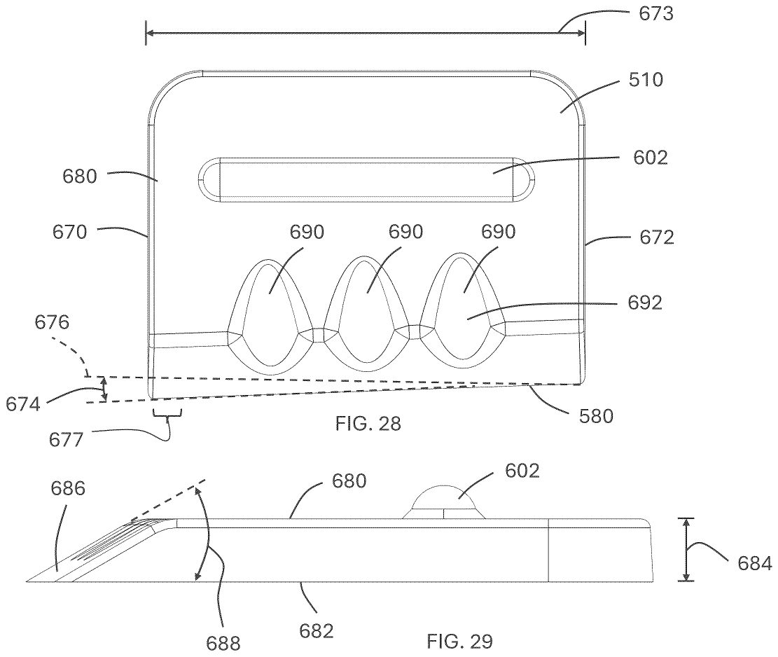

Regarding FIG. 25, the roller cleaning tool 500 has a blade holder 590 that receives the blade 510. The blade holder 590 includes a blade clamp 592 for securing the blade 510 in the blade holder 590. The blade holder 590 includes an upper clamp portion 594 of the body 506 and a lower clamp portion such as a clamp member 596 that is held tightly against the upper clamp portion 594 via bolts 598. The upper clamp portion 594 has a recess 600 that interlocks with one or more protrusions, such as a ridge 602 (see FIG. 28), of the blade 510 to position the blade 510 in the blade holder 590 and resist movement therefrom.

Regarding FIG. 26, the roller cleaning tool 500 includes the clamp release actuator 630 for shifting the over-center linkage 520 away from the over-center configuration of the links 550, 552 and pivoting the roller clamp member 522 in direction 530 to the disengaged orientation thereof. The clamp release actuator 630 includes a release lever 632 that is pivotal about a spring pin 634 that connects the release lever 632 to the body 506. The release lever 632 has a pusher 636 that contacts a lower portion 520A of the over-center linkage 520 below the spring pin 560. More specifically, a user pivots the release lever 632 in direction 640 to shift the pusher 636, lower portion 520A, and spring pin 560 upward in direction 642 which pivots the links 550, 552 together to a pitched or inclined orientation as shown in FIG. 27. The pivoting of the link 550 in direction 551 toward the link 552 causes movement of the bolt 562 in direction 650 and pivoting of the roller clamp member 522 in direction 530 toward the disengaged orientation of FIG. 27.

Regarding FIG. 27, as noted above, a user presses actuator 531 of the over-center linkage 520 in direction 529 to shift the over-center linkage 520 from the release or pitched configuration to the engaged or over-center configuration. Specifically, pressing the actuator 531 downward in direction 529 pivots the link 550 in direction 553 away from the link 552. The pivoting of the link 550 in direction 553 causes the link 550 to urge the bolt 562 in direction 651 and pivots the roller engaging member 522 in direction 533 to the engaged configuration thereof. Referring to FIGS. 23 and 26, the pivot arm portions 572 extend a distance 654 between the bolts 562, 564 and provide a lever arm for the roller clamp member 522 so that the shifting the over-center linkage 520 to the over-center configuration provides a firm engagement of the wheels 524 against the roller 504.

Regarding FIG. 28, the blade 510 has opposite side surfaces 670, 672 and a width 673 extending therebetween, such as approximately 1 inch. The scraping edge 580 extends at an angle 674 relative to an axis 676 that extends perpendicular to the side surfaces 670, 672. The bias or angle 674, such as 2 degrees, of the scraping edge 580 promotes a slicing action of the scraping edge 580. More specifically, as the scraping edge 580 encounters a sticker on the roller 504, a small portion 677 of the scraping edge 580 initially engages the sticker 700. As the roller 504 rotates, progressively more of the scraping edge 580 engages the sticker 700 until the entire scraping edge 580 engages the sticker 700. The initial engagement of the small portion 677 of the scraping edge 580 enables the small portion 677 to slice through a small region of the sticker 700 with minimal resistance from the paper and/or adhesive of the sticker 700. Continued rotation of the roller 504 and the increasing engagement of the scraping edge 580 with the sticker 700 stretches or widens the slice in the sticker 700.

Regarding FIGS. 28 and 29, the blade 510 has an upper surface 680, a lower surface 682, and a thickness 684 extending therebetween. The blade 510 has an inclined leading surface 686 extending at an angle 688 to the lower surface 670. The angle 688, such as 20 degrees, is selected to balance peeling performance with blade life. Specifically, decreasing the angle 688 increases the peeling performance while decreasing the blade life.

The blade 510 has recesses 690 in the upper surface 680 and inclined leading surface 686 to provide reduced thickness portions 692 of the blade 510 that increase the flexibility of the blade 510. Due to the bias or angle 674 of the scraping edge 580, the scraping edge 580 is subject to uneven loading as the scraping edge 580 scrapes off the sticker 700. The recesses 690 also reduce the surface area of the blade 510 that can be contacted by the sticker 700 as the sticker is scraped off by the blade 510, which reduces the likelihood of the sticker 700 adhering to the blade 510 after the sticker 700 has been scraped off by the blade 510.

Still further, the recesses 690 also provide a reservoir or compartment to receive an adhesive removing fluid (such as Goo Gone®). For example, a user may spray the adhesive removing liquid into the recesses 690 for contacting the underside of the sticker 700 as the sticker 700 is peeled off by the blade 510. By contacting the underside of the sticker 700 with the adhesive removing liquid, the adhesive of the sticker may be less like to become caught on the roller cleaning tool 500 or other object once the sticker 700 has been removed from the roller 504. Other adhesive-removing liquids that may be used with the roller cleaning tools disclosed herein include isopropyl alcohol and acetone.

Regarding FIGS. 30 and 31, the blade 510 is shown engaging the sticker 700 as the roller 504 rotates in direction 514. The scraping edge 580 has a leading portion 702 and a trailing portion 704 due to the bias of the scraping edge 580. Regarding FIG. 31, the leading portion 702 of the scraping edge 580 initially encounters the sticker 700 while there is a spacing 706 from an edge 708 of the sticker 700. As the leading portion 702 engages the edge 708 of the sticker 700, the leading portion 702 slices through the sticker 700. The portion of the scraping edge 580 engaged with the sticker 700 increases as the roller 504 rotates in direction 514.

When the blade scraping edge 580 engages the sticker 700, the sticker 700 asserts a force against the blade 510 that has a main force vector in direction 710 and a secondary force vector in direction 712. The primary force vector acting in direction 710 firmly engages the ridge 602 of the blade 510 in the recess 600 (see FIG. 25) of the upper clamp portion 594 of the body 506.

The secondary force vector acting in direction 712 urges the side surface 670 of the blade 510 against a blade support surface 714 of the body 506 as shown in FIG. 31. The urging of the blade 510 against the blade support surface 714 keeps the blade 510 from falling out of the blade holder 590 during a sticker removing operation.

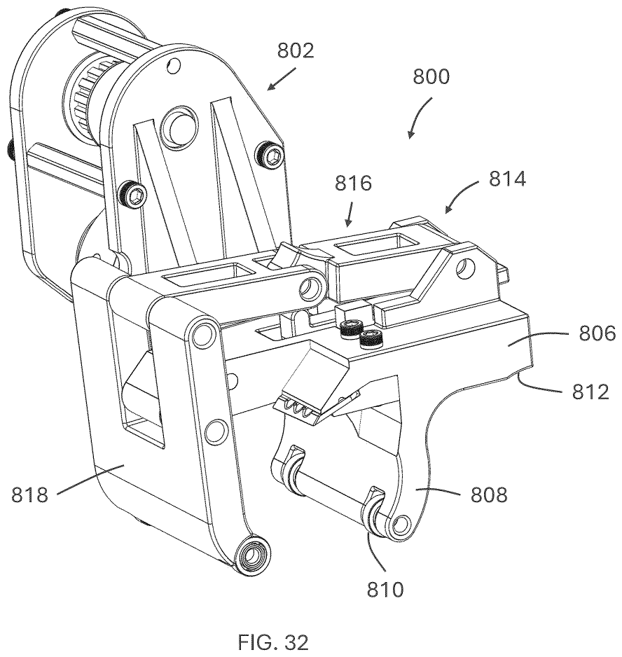

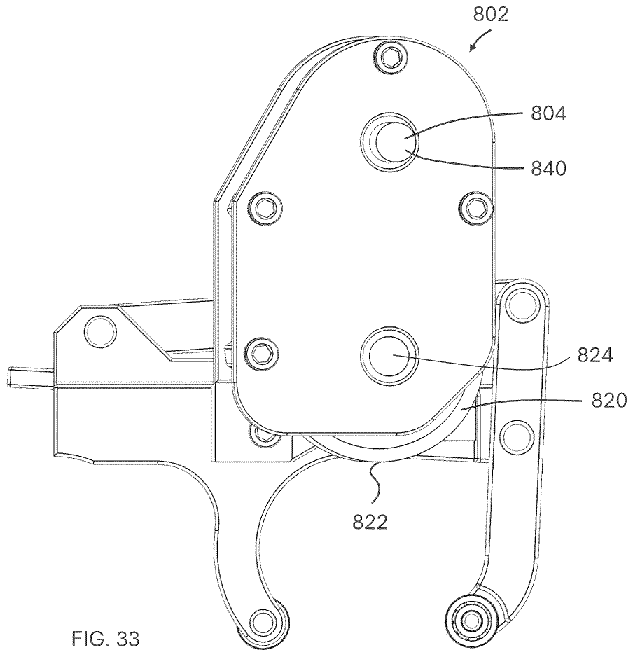

Regarding FIGS. 32 and 33, a roller cleaning tool 800 is provided that is similar in many respects to the roller cleaning tool 500 discussed above. One difference is that the roller cleaning tool 800 includes a drive 802 with an input shaft 804 that connects to a drive member, e.g., a drive bit held in a chuck of a handheld power drill. The drive 802 is operable to rotate the roller relative to the roller cleaning tool 800 and advance the roller cleaning tool 800 laterally along the roller to remove stickers from the roller. Because the user utilizes a drill to operate the drive 802, the roller cleaning tool 800 may be used to remove stickers from a roller that is not driven by a drive band of the associated roller conveyor.

As another example, the roller cleaning tool 800 may be used to remove stickers from a roller after the roller has been removed from the associated roller conveyor structure. Specifically, the user secures the roller cleaning tool 800 to the removed roller and supports the roller cleaning tool 800 in a generally stationary position as the user operates the roller cleaning tool 800 using the drill. Because the roller has been removed from the roller conveyor structure, the drive 802 rotates the roller and shifts the roller laterally relative to the roller cleaning tool 800 while the roller is supported by the roller cleaning tool 800 (which, in turn, is held stationary by the user).

Regarding FIG. 32, the roller cleaning tool 800 includes a body 806 having a fixed leg portion 808 with wheels 810 and a support portion 812 for seating on an adjacent roller. The roller cleaning tool 800 includes a roller clamp 814 with an over-center linkage 816 for pivoting a roller clamp member 818 between engaged and disengaged positions.

Regarding FIG. 33, the drive 802 has a drive wheel 820 with a contacting portion 822 to engage the roller. The contacting portion 822 may be made of, for example, a high-friction plastic or rubber material to engage and rotate the roller held by the roller clamp 814.

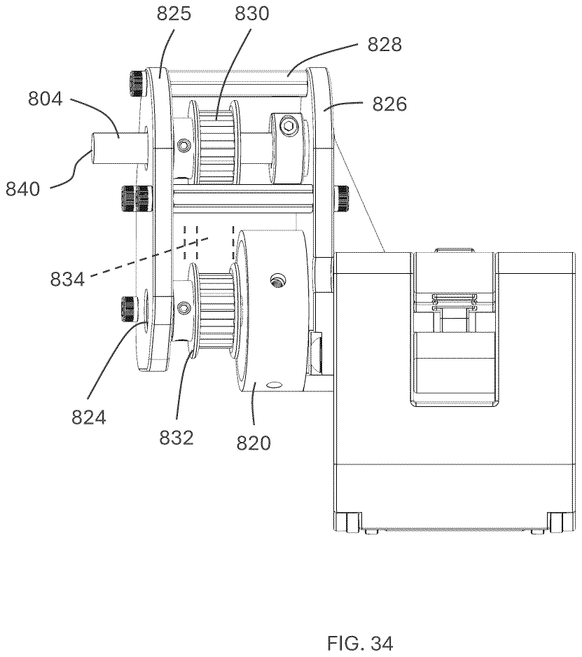

Regarding FIG. 34, the drive wheel 820 is mounted to an output shaft 824 of the drive 802. The drive 802 has plates 825, 826 separated by support members 828. The input and output shafts 804, 824 are rotatably mounted to the plates 825, 826. The drive 802 includes a drive pulley 830 mounted to the input shaft 804, a follower pulley 832 mounted to the output shaft 824, and a drive band 834 connecting the drive pulley 830 and the follower pulley 832. The input shaft 804 has a connecting portion 840, such as a socket, to receive a drive member, such as a drive bit of the drill. Turning of the input shaft 804 by the drill causes turning of the drive pulley 830, which moves the drive band 834, turns the follower pulley 832, rotates the output shaft 824, and rotates the drive wheel 820.

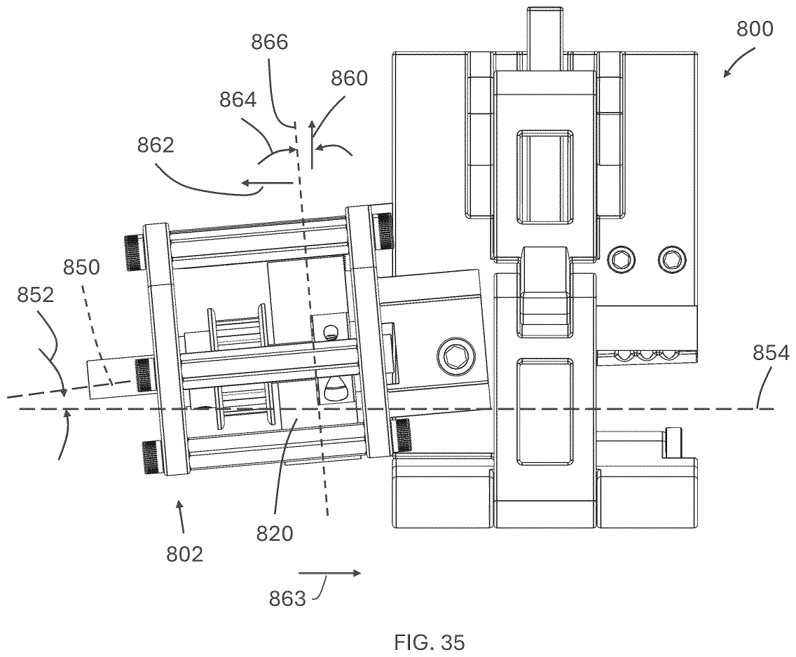

Regarding FIG. 35, the drive 802 is configured so that the rotation of the drive wheel 820 produces a rotation of the roller held between the roller clamp member 818 and the fixed leg portion 808 as well as relative lateral movement of the roller and the roller cleaning tool 800. More specifically, the drive 802 orients an axis 850 of rotation of the drive wheel 820 to extend at an angle 852, such as 15 degrees, relative to an axis 854 of rotation of the roller. The orientation of the drive wheel 820 at angle 852 causes the driving contact of the drive wheel 820 against the roller to act along an axis 866 at an angle 864 relative to a radial direction from the axis 854. The driving contact of the drive wheel 820 against the roller creates a primary force vector acting in direction 860 that produces rotation of the roller and a secondary force vector acting in direction 862 that urges the roller cleaning tool 800 in direction 862 along the roller if the roller is supported in a roller conveyor. Conversely, if the roller has been removed from the roller conveyor, the driving contact of the drive wheel 820 advances the roller in direction 863 while the user holds the roller cleaning tool 800 generally stationary.

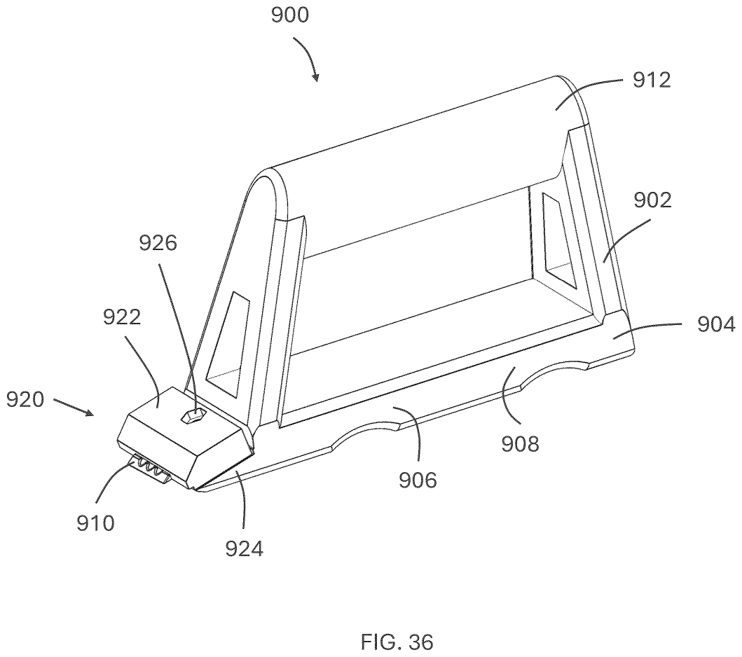

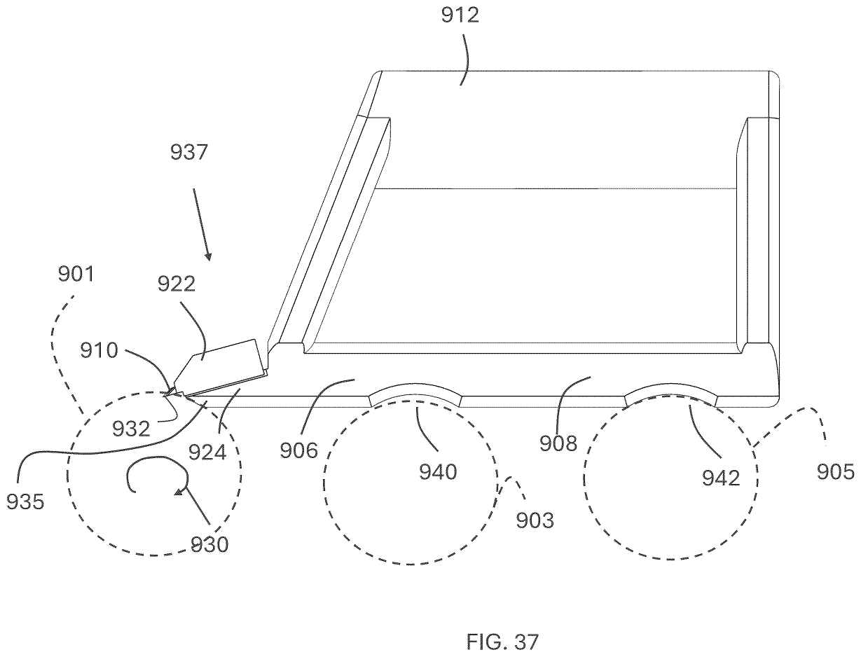

Regarding FIGS. 36 and 37, a roller cleaning tool 900 is shown having a body 902 with a base portion 904 and saddle portions 906, 908 to be positioned on an intermediate roller 903 and a downstream roller 905. The roller cleaning tool 900 further includes a blade 910 that is similar to the blade 510 discussed above for removing a sticker from an upstream roller 901. The body 902 includes a handle 912 for a user to position the roller cleaning tool 900 on the rollers 903, 905.

The roller cleaning tool 900 has a blade holder 920 with an upper clamp portion, such as clamp member 922, and a lower clamp portion, such as a tapered portion 924 of the base portion 904. The blade holder 920 includes a bolt 926 for urging the clamp member 922 toward the tapered portion 924 and sandwiching the blade 910 between the clamp member 922 and tapered portion 924.

Regarding FIG. 37, as the upstream roller turns in direction 930, a scraping edge 932 of the blade 910 can peel off a sticker from the upstream roller 901. The saddle portions 906, 908 are in sliding contact with, and supported on, the intermediate roller 903 received in a recess 940 of the saddle portion 906 and the downstream roller 905 received in a recess 942 of the saddle portion 908. The base portion 904 has a leading saddle portion 935 that engages with upstream roller 901. The leading saddle portion 935 has a short, curved surface immediately below the blade 910 to slidingly contact the cylindrical outer surface of the roller 901. The leading saddle portion 935 provides a firm engagement between a leading end portion 937 of the roller cleaning tool 900 and ensure the blade holder 920 is positioned relative to the roller 901 so that a scraping edge 932 of the blade 910 is oriented to scrape the cylindrical outer surface of the roller 901.

The user may apply a downward force against the handle 912 to keep the saddle portions 906, 908 seated against the intermediate and downstream rollers 903, 905 received in the recesses 940, 942 as the scraping edge 932 peels off a sticker from the upstream roller 901.

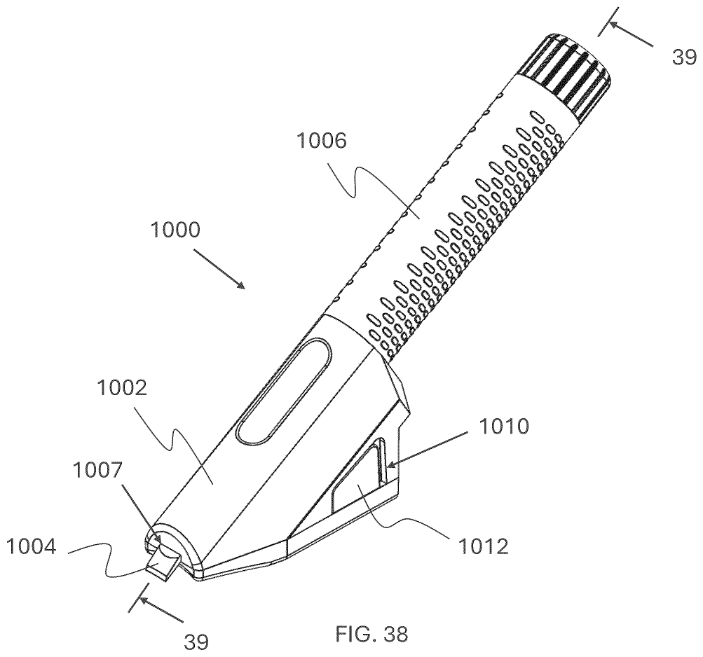

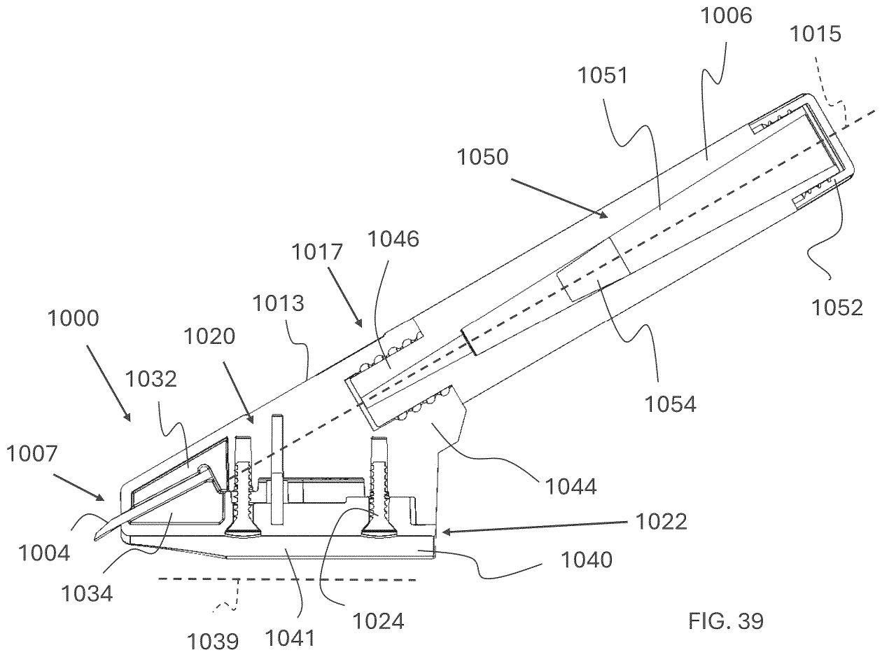

Regarding FIG. 38, a roller cleaning tool 1000 is provided that is similar in many respects to the roller cleaning tool 1000 discussed above. The roller cleaning tool 1000 includes a cleaning head 1002, a distal scraping blade 1004, and a proximal handle 1006. As best seen in FIG. 39, the cleaning head 1002 has a wedge configuration with an upper inclined surface 1013 extending along a central tool inclined axis 1015. The proximal handle 1006 is connected to an upper, proximal end portion 1017 of the cleaning head 1002 and extends upwardly and rearwardly therefrom along the tool inclined axis 1015.

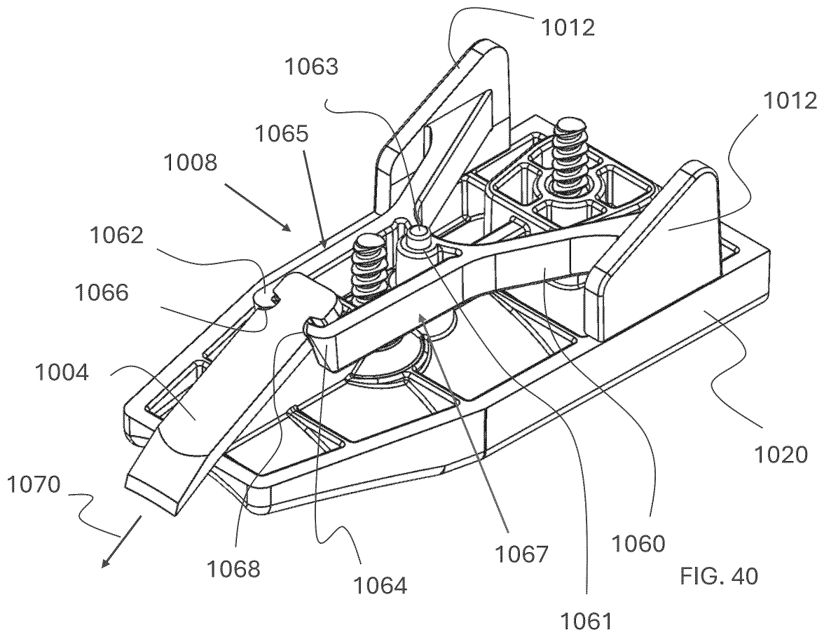

The roller cleaning tool 1000 includes a blade holder 1007 with a blade retainer 1008 (see FIG. 40) having an engaged configuration that retains the scraping blade 1004 in the cleaning head 1002 and a release configuration that permits the scraping blade 1004 to be removed from the cleaning head 1002. The blade retainer 1008 has an actuator 1010, such as buttons 1012, that are pressed by a user to shift the blade retainer 1008 from the engaged configuration to the release configuration. The blade retainer 1008 resiliently returns from the release configuration to the engaged configuration when the user releases the buttons 1012, with or without the presence of a blade 1004 in the blade holder 1007.

With reference to FIG. 39, the cleaning head 1002 includes an upper portion 1020, a lower portion 1022, and fasteners 1024 connecting the upper and lower portions 1020, 1022. The upper and lower portions 1020, 1022 cooperate to form the blade holder 1007. The blade holder 1007 includes upper and lower inclined blade supports 1032, 1034 that orient the scraping blade 1004 to extend obliquely to a central axis 1039 of a saddle portion 1040 of the lower portion 1022. The saddle portion 1040 is configured to seat generally flush on the cylindrical outer surface of a roller.

The upper portion 1020 includes a threaded female portion 1044 configured to receive a threaded male portion 1046 of the handle 1006. The handle 1006 has a compartment 1050 to receive spare scraping blades 1004 and a cap 1052 that may be removed to access an interior 1051 of the compartment 1050. The handle 1006 further includes a stopper 1054, such as a rubber plug, to inhibit the scraper blades 1004 stored in the interior 1051 from sliding too far down into the interior 1051.

Regarding FIG. 40, the scraping blade 1004 and the lower portion 1020 of the cleaning head 1002 are shown. The blade retainer 1008 includes a resilient member 1060 having gripping portions 1062, 1064 that engage recesses 1066, 1068 of the scraping blade 1004 to secure the scraping blade 1004 in the cleaning head 1002. The resilient member 1060 includes a hole 1061 that receives a pin 1063 of the lower portion 1020. The resilient member 1060 has halves 1065, 1067 each with one of the buttons 1012 and gripping portions 1062, 1064. The engagement of the hole 1061 and pin 1063 positions the resilient member 1060 in the lower portion 1020 while providing a fulcrum point for the halves 1065, 1067.

The blade retainer 1008 is shown in the engaged configuration in FIG. 40. To shift the blade retainer 1008 to the release configuration, the buttons 1012 are urged toward one another which pivots the halves 1065, 1067 about the pin 1063 and shifts the gripping portions 1062, 1064 apart to a less-engaged position with the recesses 1066, 1068. The user may then pull the scraping blade 1004 in direction 1070 to disconnect the scraping blade 1004 from the cleaning head 1002.

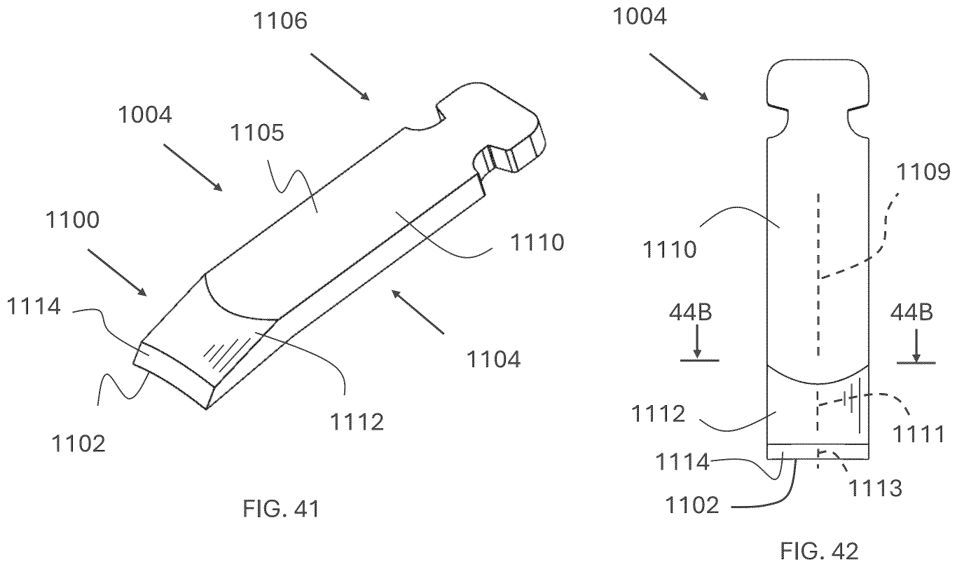

Regarding FIGS. 41 and 42, the scraping blade 1004 is similar to the scraping blade 14 discussed above. The scraping blade 1004 has a body 1105 made of a material having a flexure modulus of at least 1.8 GPa, such as at least 50 GPa. In this manner, the blade 1004 is relatively rigid but is able to be slightly bent when applying sufficient force thereto against a roller during a scraping operation. The generally bent or oblique configuration of the blade body 1105 further assists in this regard. The body 1105 has a distal tip portion 1100 with an arcuate scraping edge 1102, a shank portion 1104, and an attachment portion 1106. The scraping blade 1004 has a flat upper surface 1110 and the distal tip portion 1100 has a tapered lead-in surface 1112 tapering downwardly from the flat upper surface 1110. In other words, central axes 1109, 1111 (see FIG. 42) of the respective surfaces 1110 and 1112 extend obliquely to each other. The downwardly tapered lead-in surface 1112 has a convex, cylindrical shape so that it curves about the central axis 1111. For this purpose, the convex lead-in surface 1112 may be formed by bending the body 1105 of the scraping blade 1004 around a mandrel with a cylindrical outer surface during manufacture of the scraping blade 1004. The distal tip portion 1100 further includes an upper tapered edge surface 1114 tapering downwardly from the tapered lead-in surface 1112. The upper tapered edge surface 1114 has a convex, cylindrical shape so that it curves about its corresponding central axis 1113 which extends obliquely to the central axis 1111 of the lead-in surface 1112.

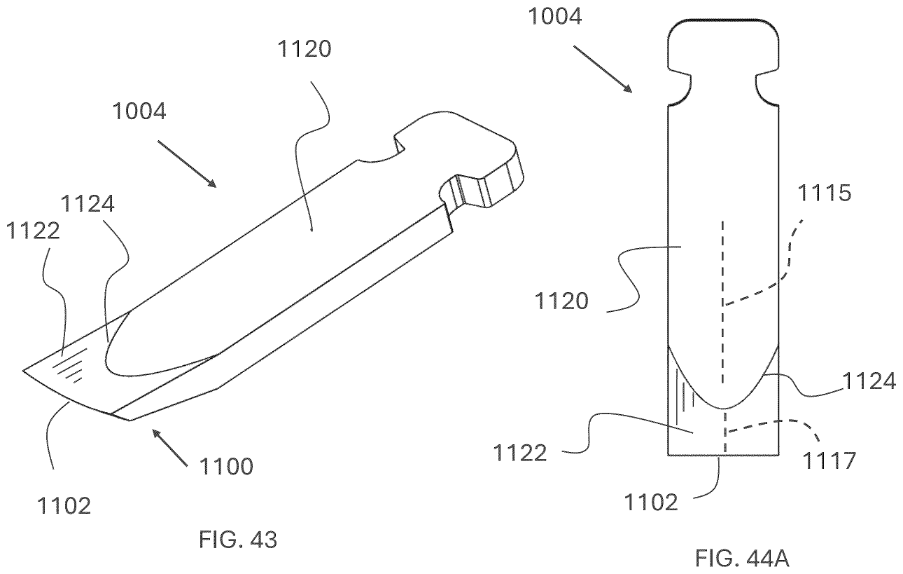

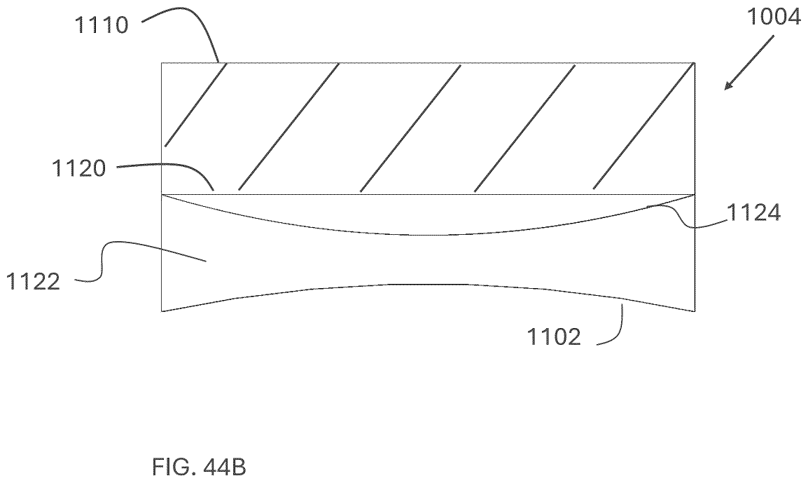

Regarding FIGS. 43 and 44A, the scraping blade 1004 has a flat lower surface 1120. The distal tip portion 1100 includes a lower tapered edge surface 1122 extending downward (upwardly in FIG. 43) from a curved juncture 1124 with the flat lower surface 1120. Thus, central axes 1115, 1117 of the respective surfaces 1120 and 1122 extend obliquely to each other. The lower tapered edge surface 1122 is a concave, cylindrical surface so that it curves about its central axis 1117 to be configured to complement the cylindrical outer surface of a roller. The cylindrical shape of the lower tapered edge surface 1122 may be formed by bending the body 1105 of the scraping blade 1004 around a mandrel with a cylindrical outer surface during manufacture of the scraping blade 1004. The concave, cylindrical profile of the lower tapered edge surface 1122 is shown in FIG. 44B.

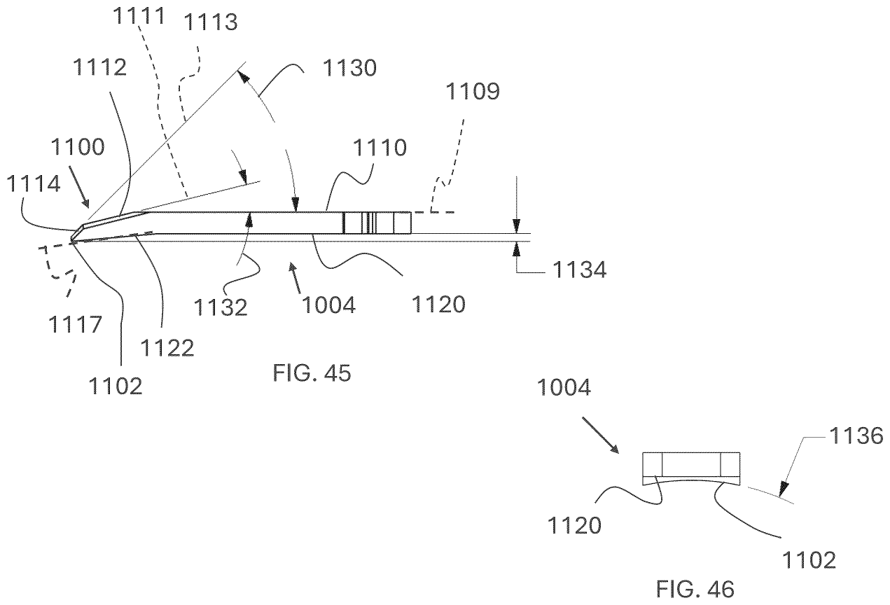

With reference to FIG. 45, the central axis 1113 of the upper tapered edge surface 1114 extends at an oblique angle 1130 relative to the central axis 1109 of the flat upper surface 1110 of the scraping blade 1004. The central axis 1111 of the tapered lead-in surface 1112 extends at a smaller oblique angle 1132 relative to the central axis 1109 of the flat upper surface 1110. In one embodiment, the angle 1130 is 45 degrees and the angle 1132 is 14 degrees. The angle 1130 is larger than the angle 160 (see FIG. 7) of the scraping blade 14 such that the upper tapered edge surface 1114 has a greater angle of attack, or steeper slope, than the upper tapered edge surface 152 of the scraping blade 14. The upper tapered edge surface 1114 may be formed by shearing off material, such as stamping, of the distal tip portion 1100 after the lower tapered edge surface 1122 has been formed by stamping the scraping blade 1004 around a cylindrical outer surface of a mandrel. Further, the central axis 1117 of the lower tapered edge surface 1122 extends obliquely to the central axis 1115 of the flat lower surface 1120.

As shown in FIGS. 45 and 46 with the scraping blade 1004 oriented so that the central axis 1109 of the flat upper surface 1110 extends horizontally, the scraping edge 1102 is offset by a distance 1134 below the flat lower surface 1120 of the scraping blade 1004. The scraping edge 1102 has a radius 1136 sized to be slightly smaller than the radius of the cylindrical outer surface of a roller, as discussed above.

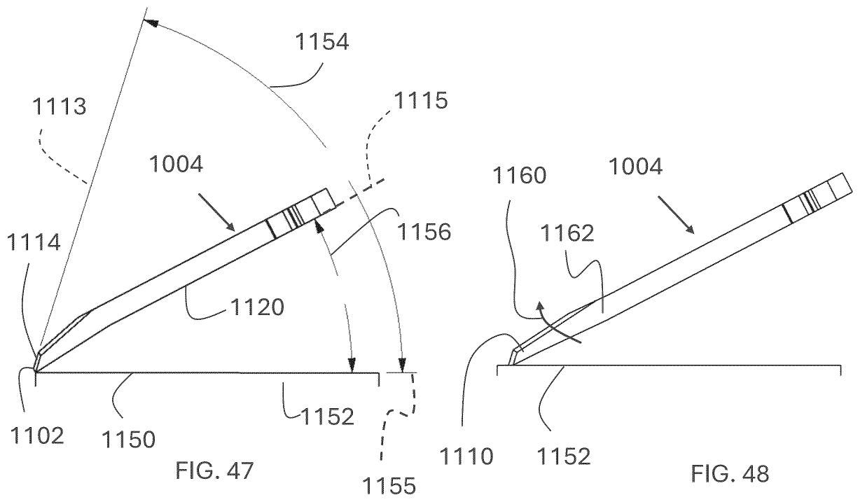

With reference to FIG. 47, the scraping blade 1004 is shown in an initial configuration when the roller cleaning tool 1000 is positioned on a cylindrical outer surface 1150 of a roller 1152 but the saddle portion 1040 is not yet seated on the roller 1152. The central axis 1113 of the upper tapered edge surface 1114 extends at an oblique angle 1154 relative to a central axis 1155 of the cylindrical outer surface 1150 of the cylindrical roller 1152 while the central axis 1115 of the flat lower surface 1120 extends at an oblique angle 1156 relative to the central axis 1155 of the cylindrical outer surface 1150. The oblique angle 1154 may be 73 degrees and the oblique angle 1156 may be 27.5 degrees, for example.

In FIG. 48, the scraping blade 1004 is shown in a deflected configuration that corresponds to a use configuration of the scraping blade 1004 when the user has pressed the roller cleaning tool 1000 against the roller 1152 and seated the saddle portion 1040 on the outer cylindrical surface 1150 of the roller 1152. In one approach, the saddle portion 1040 is seated on the outer cylindrical surface 1150 when an entirety of the concave lower surface 1041 of the saddle portion 1040 such that the concave lower surface 1041 extends concentrically around and along the outer cylindrical surface 1150. The seating of the saddle portion 1040 downwardly onto the outer cylindrical surface 1150, in a manner similar to the movement shown in FIGS. 17, 18, deflects the distal tip portion 1100 upward in direction 1160 due to the interference between the distal tip portion 1100 and the outer cylindrical surface 1150 and forms a bent portion 1162 in the scraping blade 1004. The user presses the roller cleaning tool 1000 against the roller cylindrical outer surface 1150, such as with a force of 20-30 lbs, to seat the saddle portion 1040 on the outer cylindrical surface 1150 and overcome the resistance of the scraping blade 1004 deflecting from the initial configuration of FIG. 47 to the deflected configuration of FIG. 48.

In other words, when the saddle portion 1040 is seated on the roller cylindrical outer surface 1150, the scraping blade 1004 is deflected with to include the bent portion 1162 and the arcuate scraping edge 1102 is flattened out to fully engage the roller cylindrical outer surface as discussed above with respect to FIGS. 10 and 11. In this manner, the roller cleaning tool 1000 will automatically deflect the scraping blade 1004 and fully engage the arcuate scraping edge 1102 when the user seats the saddle portion 1040 on the roller cylindrical outer surface 1150.

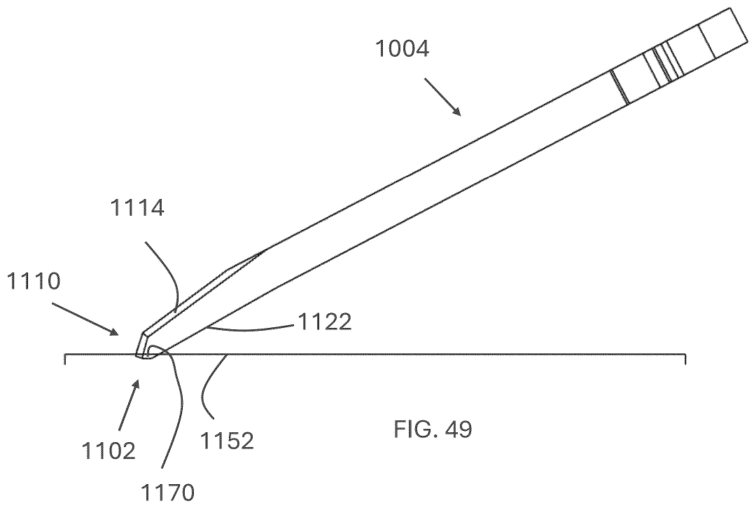

With reference to FIG. 49, the scraping blade 1004 is shown in an initial, undeflected configuration similar to FIG. 47 but with the distal tip portion 1100 having been worn down by use of the roller cleaning tool 1000. The arcuate scraping edge 1102 has developed an arcuate face or surface 1170 due to the dulling of the distal tip portion 1100. The arcuate surface 1170 connects the upper and lower tapered edge surfaces 1114, 1122 and extends around the cylindrical outer surface 1150.

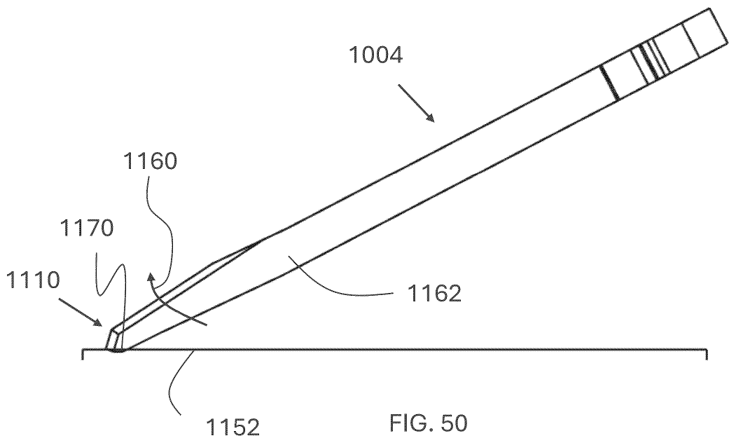

With reference to FIG. 50, the scraping blade 1004 with the worn distal tip portion 1100 is shown in the deflected configuration when the user has pressed the roller cleaning tool 1000 against the roller 1152 and seated the saddle portion 1040 on the outer cylindrical surface 1150 of the roller 1152. The distal tip portion 1100 is deflected in direction 1160 and the scraping blade 1004 has the bent portion 1162 caused by the deflection of the distal tip portion 1100. The deflection of the distal tip portion 1100 is less pronounced in FIG. 50 than in FIG. 48 due to the shorter, worn distal tip portion 1100. The arcuate scraping edge surface 1170 is engaged with the cylindrical outer surface 1150 of the roller 1152 despite the worn distal tip portion 1100, which enables the scraping blade 1004 to continue to be used to remove stickers from the cylindrical outer surface 1150.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B.

While there have been illustrated and described particular embodiments of the present invention, it will be appreciated that numerous changes and modifications will occur to those skilled in the art, and it is intended for the present invention to cover all those changes and modifications which fall within the scope of the appended claims.

1. A scraping blade for a roller conveyor cleaning tool, the scraping blade comprising:
a blade body;
a proximal attachment portion of the body;
an elongate shank portion of the body extending longitudinally from the proximal attachment portion;
a distal tip portion of the body extending downwardly from the shank portion; and
a lower arcuate scraping edge of the distal tip portion configured to engage a cylindrical outer surface of a roller.

2. The scraping blade of claim 1 wherein the elongate shank portion and the distal tip portion extend transverse to each other.

3. The scraping blade of claim 1 wherein the elongate shank portion has a shank central axis, the distal tip portion has a tip central axis, and the shank central axis and the tip central axis extend obliquely to each other.

4. The scraping blade of claim 1 wherein the blade body is of a material having a flexure modulus of at least 1.8 gigapascals.

5. The scraping blade of claim 1 wherein the blade body is of a material having a flexure modulus of at least 50 gigapascals.

6. The scraping blade of claim 1 wherein the elongate blade body includes longitudinal sides; and
wherein the proximal attachment portion includes recesses extending laterally inward from the longitudinal sides to receive gripping portions of the roller conveyor cleaning tool.

7. The scraping blade of claim 1 wherein the proximal attachment portion of the body includes a head portion, a neck portion, and recesses on either side of neck portion to receive gripping portions of the roller conveyor cleaning tool.

8. The scraping blade of claim 7 wherein the head portion includes proximal tapered side surfaces to engage and urge the gripping portions apart as the scraping blade is connected to the roller conveyor cleaning tool.

9. The scraping blade of claim 7 wherein the head portion includes distal tapered side surfaces extending along the recesses and configured to urge the gripping portions apart as the scraping blade is disconnected from the roller conveyor cleaning tool.

10. The scraping blade of claim 1 wherein the lower arcuate scraping edge includes laterally outer corners and a central portion intermediate the corners; and
wherein the distal tip portion is configured to permit the corners to resiliently shift apart and the central portion to shift toward the cylindrical outer surface of the roller as the arcuate scraping edge engages the cylindrical outer surface of the roller.

11. The scraping blade of claim 1 wherein the distal tip portion includes:
an upper, arcuate tapered edge surface that is convex;
a lower, arcuate tapered edge surface that is concave; and
the lower arcuate scraping edge connects the upper and lower arcuate tapered edge surfaces.

12. The scraping blade of claim 11 wherein the distal tip portion includes longitudinal side surface portions; and
wherein the upper and lower arcuate tapered edge surfaces extend laterally between the longitudinal side surface portions.

13. The scraping blade of claim 11 wherein the blade body comprises a flat lower surface and the lower tapered edge surface extends obliquely downwardly and distally from the flat lower surface to the arcuate scraping edge.

14. The scraping blade of claim 13 wherein the blade body comprises a flat upper surface and a convex, intermediate tapered upper surface extending obliquely downwardly and distally from the flat upper surface to the upper arcuate tapered edge surface of the distal tip portion.

15. The scraping blade of claim 14 wherein the blade body includes an arcuate juncture between the convex, intermediate tapered upper surface and the upper arcuate tapered edge surface.

16. The scraping blade of claim 1 wherein the blade body includes straight, parallel longitudinal sides extending from the proximal attachment portion to the distal tip portion.

17. The scraping blade of claim 1 wherein the blade body has a flat lower surface; and
wherein the distal tip portion includes a lower, cylindrical tapered edge surface having a concave configuration and having a central axis extending obliquely to a central axis of the flat lower surface of the elongate body.

18. The scraping blade of claim 1 wherein the blade body is made of a metallic material.

19. A roller cleaning tool for cleaning rollers of a roller conveyor, the roller cleaning tool comprising:
an arcuate saddle portion configured to be seated against a cylindrical outer surface of a roller;
a scraping blade; and
an arcuate scraping edge of the scraping blade spaced from the arcuate saddle portion and configured to engage the roller cylindrical outer surface with the saddle portion seated on the cylindrical outer surface.

20. The roller cleaning tool of claim 19 wherein the arcuate saddle portion extends about a central axis; and
wherein the arcuate scraping edge of the scraping blade is spaced from the arcuate saddle portion along the central axis.

21. The roller cleaning tool of claim 20 further comprising a handle extending upwardly and rearwardly of the arcuate saddle portion; and
wherein the arcuate scraping edge of the scraping blade is spaced forwardly of the arcuate saddle portion along the central axis.

22. The roller cleaning tool of claim 19 wherein the arcuate saddle portion and the scraping blade are arranged and configured so that with the saddle portion seated on the roller cylindrical outer surface, the scraping blade will be engaged with and deflected by the roller cylindrical outer surface.

23. The roller cleaning tool of claim 19 wherein the saddle portion has a concave lower surface with a first radius of curvature to complement the cylindrical outer surface of the roller; and
wherein the arcuate scraping edge of the scraping blade has a second radius of curvature that is smaller than the first radius of curvature.

24. The roller cleaning tool of claim 23 wherein the second radius of curvature is in a range of approximately 94% to approximately 96% of the first radius of curvature.

25. The roller cleaning tool of claim 19 wherein the arcuate scraping edge is below at least a central portion of the arcuate saddle portion.

26. The roller cleaning tool of claim 19 wherein the arcuate saddle portion extends about a central axis; and
a blade holder connected to the saddle portion and configured to orient the scraping blade to extend transverse to the central axis.

27. The roller cleaning tool of claim 19 wherein the arcuate scraping edge of the scraping blade includes a pair of opposite corners and a central portion intermediate the corners; and
wherein the scraping blade is configured to permit the corners to shift apart as the saddle portion is seated on the roller cylindrical outer surface.

28. The roller cleaning tool of claim 19 further comprising a blade holder configured to support the scraping blade; and
wherein the blade holder includes a blade retainer having a disengaged configuration that permits the scraping blade to be connected to the blade holder and an engaged configuration that inhibits the scraping blade from being disconnected from the blade holder.

29. The roller cleaning tool of claim 28 wherein the scraping blade includes at least one recess; and
wherein the retainer includes at least one gripping portion configured to extend in the at least one recess with the blade holder in the engaged configuration to inhibit movement of the scraping blade relative to the retainer.

30. The roller cleaning tool of claim 29 wherein the scraping blade includes opposite longitudinal sides and recesses extending laterally inward from the longitudinal sides; and
wherein the retainer includes gripping portions for extending into the recesses of the scraping blade, the gripping portions having a first distance therebetween with the retainer in the disengaged configuration and a second distance less than the first distance with the retainer in the engaged configuration to inhibit separation of the scraping blade from the blade holder.

31. The roller cleaning tool of claim 19 further comprising a handle connected to the saddle portion; and
wherein the handle includes a compartment to receive at least one other scraping blade.

32-38. (canceled)
